(19) United States
(12) Patent Application Publication
(10) Pub. No.: US 2018/0267574 A1
(43) Pub. Date: Sep. 20, 2018

(54) FLEXIBLE DEVICE AND METHOD OF CONTROLLING SHAPE OF DISPLAY OF FLEXIBLE DEVICE

(71) Applicant: Samsung Electronics Co., Ltd., Suwon-si, Gyeonggi-do (KR)

(72) Inventors: Shi-yun CHO, Anyang-si (KR); Hee-seok JEONG, Suwon-si (KR)

(21) Appl. No.: 15/542,589

(22) PCT Filed: Oct. 29, 2015
(86) PCT No.: PCT/KR2015/011476

§ 371 Date: Jul. 10, 2017

(30) Foreign Application Priority Data
Jan. 19, 2015 (KR) 10-2015-0008764

(51) Int. Cl. G06F 1/16; G06F 3/041; G06F 3/01; G06F 3/0487; H04M 1/02

(52) U.S. Cl. CPC G06F 1/1652; G06F 1/1601; G06F 1/1641; G06F 1/1677; G09F 9/301; G06F 3/017; G06F 3/0487; H04M 1/0268; G06F 3/0414

(57) ABSTRACT

A flexible device comprises a flexible display that has a foldable deformable part; a housing that is foldable and forms an enclosure space in which the deformable part is enclosed when the flexible display is deformed; a shape maintaining part that is arranged in the enclosure space so as to control flexibility of the deformable part; and an electrical signal applier that applies an electrical signal to the shape maintaining part, based on a deformation state of the flexible display.

### TECHNICAL FIELD

The present disclosure relates to a flexible device having a flexible display and a method of controlling a shape of the flexible display, the method performed by the flexible device having the flexible display.

### BACKGROUND ART

According to developments in a display-related technology, a flexible display, a transparent display panel, or the like are being developed. The flexible display indicates a display device that may be bent.

The flexible display is manufactured in a manner that a plastic film is substituted for a glass substrate that encapsulates liquid crystals in a liquid crystal display (LCD) and an organic light-emitting display (OLED) according to the related art, thus, the flexible display has foldable and unfoldable flexibility. In the flexible display, a plastic substrate is used instead of a generally-used glass substrate, thus, a low temperature manufacturing process is performed, instead of a conventional manufacturing process, so as to prevent damage to a substrate.

The flexible display is thin, light-weighted, and resistant to a shock. In addition, the flexible display may be flexible or bent, and may be manufactured to have one of various shapes. In particular, the flexible display may be used in industrial applications where conventional glass-based displays are limitedly used or cannot be used.

For example, the flexible display may be used in electronic books that may be substituted for publications such as magazines, textbooks, general books, comic books, etc., and may be used in new portable Information Technology (IT) products such as ultra-small portable personal computers whose displays may be bent or rolled, a smart card capable of checking information in real-time, or the like. In addition, since a flexible plastic substrate is used in the flexible display, application fields of the flexible display may expand to wearable clothes and medical diagnosis fields.

### DISCLOSURE OF INVENTION

Provided are a flexible device having a flexible display and a method of controlling a shape of the flexible display, the method performed by the flexible device having the flexible display.

Provided is a non-transitory computer-readable recording medium having recorded thereon a program for executing the method, by using a computer.

Additional aspects will be set forth in part in the description which follows and, in part, will be apparent from the description, or may be learned by practice of the presented exemplary embodiments.

According to an aspect of an exemplary embodiment, a flexible device includes a flexible display that has a foldable deformable part; a housing that is foldable and forms an enclosure space in which the deformable part is enclosed when the flexible display is deformed; a shape maintaining part that is arranged in the enclosure space so as to control flexibility of the deformable part; and an electrical signal applier that applies an electrical signal to the shape maintaining part, based on a deformation state of the flexible display.

### BRIEF DESCRIPTION OF DRAWINGS

These and/or other aspects will become apparent and more readily appreciated from the following description of the exemplary embodiments, taken in conjunction with the accompanying drawings in which:

FIGS. 1A through 1C illustrate exterior shapes of a flexible device in correspondence to folding motions of the flexible device, according to exemplary embodiments;

FIG. 2 is a cross-sectional side view of the flexible device shown in FIG. 1;

FIG. 3 is a cross-sectional side view of a flexible device, according to another exemplary embodiment;

FIG. 4 illustrates the flexible device according to the exemplary embodiment and another flexible device that does not include a shape maintaining part according to a comparative example;

FIG. 5 illustrates an operation principal with respect to the shape maintaining part shown in FIG. 4;

FIGS. 6 and 7 illustrate characteristics of a device that is used in embodying the shape maintaining part described with reference to FIG. 5;

FIG. 8 is a cross-sectional side view illustrating a portion of the flexible device, according to another exemplary embodiment;

FIG. 9 is a cross-sectional side view illustrating a portion of the flexible device shown in FIG. 8 when the flexible device is folded;

FIG. 10 is a cross-sectional side view illustrating a portion of the flexible device, according to another exemplary embodiment;

FIG. 11 is a cross-sectional side view illustrating a portion of a flexible device, according to another exemplary embodiment;

FIG. 12 is a cross-sectional side view illustrating a portion of the flexible device of FIG. 8 when the flexible device is bent in an opposite direction;

FIG. 13 is a cross-sectional side view illustrating a portion of the flexible device of FIG. 10 when the flexible device is bent in an opposite direction;

FIG. 14 is a cross-sectional side view illustrating a portion of the flexible device of FIG. 11 when the flexible device is bent in an opposite direction;

FIG. 15 illustrates the shape maintaining part of the flexible device, according to an exemplary embodiment;

FIG. 16 illustrates a shape maintaining part of the flexible device, according to another exemplary embodiment;

FIG. 17 illustrates a shape maintaining part of the flexible device, according to another exemplary embodiment;

FIG. 18 illustrates a shape maintaining part of the flexible device, according to another exemplary embodiment;

FIG. 19 illustrates a shape maintaining part of the flexible device, according to another exemplary embodiment;

FIG. 20 illustrates the shape maintaining part of FIG. 15;

FIG. 21 illustrates the shape maintaining part of FIG. 16;

FIG. 22 illustrates the shape maintaining part of FIG. 19;

FIG. 23 illustrates a process of sensing a folding motion of the flexible display, according to an exemplary embodiment;

FIG. 24A illustrates a process of sensing a folding motion of the flexible display, the process performed by a sensing unit, according to an exemplary embodiment;

FIG. 24B illustrates a process of sensing a folding motion of the flexible display, the process performed by a sensing unit, according to another exemplary embodiment;

FIG. 25A illustrates a process of sensing a folding motion of the flexible display, the process performed by a sensing unit, according to another exemplary embodiment;

FIG. 25B illustrates a process of sensing a folding motion of the flexible display, the process performed by a sensing unit, according to another exemplary embodiment;

FIG. 26 illustrates a process of sensing a folding motion of the flexible display, the process performed by a sensing unit, according to another exemplary embodiment;

FIGS. 27A through 27C illustrate a procedure of controlling the flexible display of the flexible device including the shape maintaining part of FIG. 20, the procedure performed by the flexible device, according to an exemplary embodiment;

FIGS. 28A through 28C illustrate a procedure of controlling the flexible display of the flexible device including the shape maintaining part of FIG. 21, the procedure performed by the flexible device, according to another exemplary embodiment;

FIGS. 29A and 29B illustrate a procedure of controlling the flexible display of the flexible device including the shape maintaining part of FIG. 22, the procedure performed by the flexible device, according to another exemplary embodiment;

FIG. 30 is an exploded perspective view of the flexible device, according to an exemplary embodiment;

FIG. 31 is a block diagram illustrating a configuration of the flexible device of FIG. 30, according to an exemplary embodiment;

FIG. 32 is a block diagram illustrating a configuration of the flexible device, according to another exemplary embodiment;

FIG. 33 is a flowchart of a method of controlling flexibility of the flexible display, the method performed by the flexible device of FIG. 30, according to an exemplary embodiment; and

FIG. 34 is a flowchart of a method of controlling flexibility of the flexible display, the method performed by the flexible device of FIG. 30, according to another exemplary embodiment.

### BEST MODE FOR CARRYING OUT THE INVENTION

According to an aspect of an exemplary embodiment, a flexible device includes a flexible display that has a foldable deformable part; a housing that is foldable and forms an enclosure space in which the deformable part is enclosed when the flexible display is deformed; a shape maintaining part that is arranged in the enclosure space so as to control flexibility of the deformable part; and an electrical signal applier that applies an electrical signal to the shape maintaining part, based on a deformation state of the flexible display.

The flexible display may include a first part, a second part, and the deformable part between the first part and the second part, and the first part and the second part may be fixed to the housing, and the deformable part may not be fixed to the housing.

The shape maintaining part may be arranged on a rear surface of the deformable part in the enclosure space.

The shape maintaining part may include a shape-maintaining device whose shape is deformed according to the electrical signal received from the electrical signal applier.

When the shape maintaining part receives the electrical signal from the electrical signal applier, the shape maintaining part may maintain a preset shape, and when the electrical signal is blocked, a shape of the shape maintaining part may be deformed according to a deformed shape of the deformable part having the shape maintaining part arranged on its rear surface.

The flexible device may further include a sensing unit that senses the deformation state of the flexible display.

The sensing unit may sense the deformation state of the flexible display by sensing an unfolding angle or an unfolding curvature of the flexible display.

The electrical signal applier may apply the electrical signal to an area of the shape maintaining part that corresponds to the deformation state of the flexible display.

According to an aspect of another exemplary embodiment, a flexible device includes a flexible display that has a foldable deformable part; a sensing unit that senses a deformation state of the flexible display; an electrical signal applier that applies an electrical signal to a shape maintaining part that is arranged on a rear surface of the deformable part in an enclosure space in which the deformable part is enclosed when the flexible display is deformed; and a controller that controls the electrical signal applier to apply the electrical signal to the shape maintaining part, based on the deformation state.

The sensing unit may sense an unfolding angle or an unfolding curvature of the flexible display, and the controller may determine, based on the sensed unfolding angle or the sensed unfolding curvature, whether or not to apply the electrical signal to the shape maintaining part.

The controller may determine, based on the deformation state, an area of the shape maintaining part to which the electrical signal is to be applied.

The controller may determine, based on the deformation state, a magnitude of the electrical signal to be applied to an area of the shape maintaining part.

According to an aspect of another exemplary embodiment, a method of controlling flexibility of a foldable deformable part of a flexible display includes operations of sensing a deformation state of flexible display; and applying, based on the deformation state, an electrical signal to a shape maintaining part that controls the flexibility of the deformable part, wherein the shape maintaining part is arranged on a rear surface of the deformable part in an enclosure space in which the deformable part is enclosed when the flexible display is deformed.

The sensing may include sensing the deformation state by sensing an unfolding angle or an unfolding curvature of the flexible display.

The applying may include applying the electrical signal to an area of the shape maintaining part that corresponds to the deformation state.

The applying may include, based on the deformation state, determining whether or not to apply the electrical signal to the shape maintaining part; and when it is determined to apply the electrical signal, applying the electrical signal to the shape maintaining part.

The applying may include, based on the deformation state, determining an area of the shape maintaining part to which the electrical signal is to be applied; and applying the electrical signal to the determined area of the shape maintaining part.

The applying may include, based on the deformation state, determining a magnitude of the electrical signal to be applied to an area of the shape maintaining part; and applying the electrical signal having the determined magnitude to the area of the shape maintaining part.

### MODE FOR THE INVENTION

Hereinafter, terms that are used in the specification will be briefly described, and exemplary embodiments will be described in detail.

All terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Also, some terms may be arbitrarily selected by the applicant, and in this case, the meaning of the selected terms will be described in detail in the detailed description of exemplary embodiments. Thus, the terms used herein have to be defined based on the meaning of the terms together with the description throughout the specification.

Also, when a part “includes” or “comprises” an element, unless there is a particular description contrary thereto, the part can further include other elements, not excluding the other elements. In the following description, terms such as “unit” and “module” indicate a unit for processing at least one function or operation, wherein the unit and the block may be embodied as hardware or software or embodied by combining hardware and software.

Throughout the specification, the term “folding motion” or “bending motion” indicates a motion by which a flexible device or a flexible display is folded or is bent. On the other hand, throughout the specification, the term “unfolding motion” or “unbending motion” indicates a motion by which the flexible device or the flexible display is unfolded.

In particular, throughout the specification, the term “deforming” such as “folding” or “bending”, means a status in which an exterior shape of the flexible device is changed. Therefore, throughout the specification, the term “deforming” may be substituted with the term “folding”, “unfolding”, “bending”, or “unbending”, which may all be interpreted as having the same meaning as “deforming”.

Exemplary embodiments will now be described more fully with reference to the accompanying drawings. However, the exemplary embodiments may be embodied in many different forms, and should not be construed as being limited to the embodiments set forth herein; rather, these embodiments are provided so that this disclosure will be thorough and complete, and will fully convey the concept of the exemplary embodiments to one of ordinary skill in the art. In the following description, well-known functions or constructions are not described in detail since they would obscure the exemplary embodiments with unnecessary detail, and like reference numerals in the drawings denote like or similar elements throughout the specification.

Expressions such as “at least one of,” when preceding a list of elements, modify the entire list of elements and do not modify the individual elements of the list.

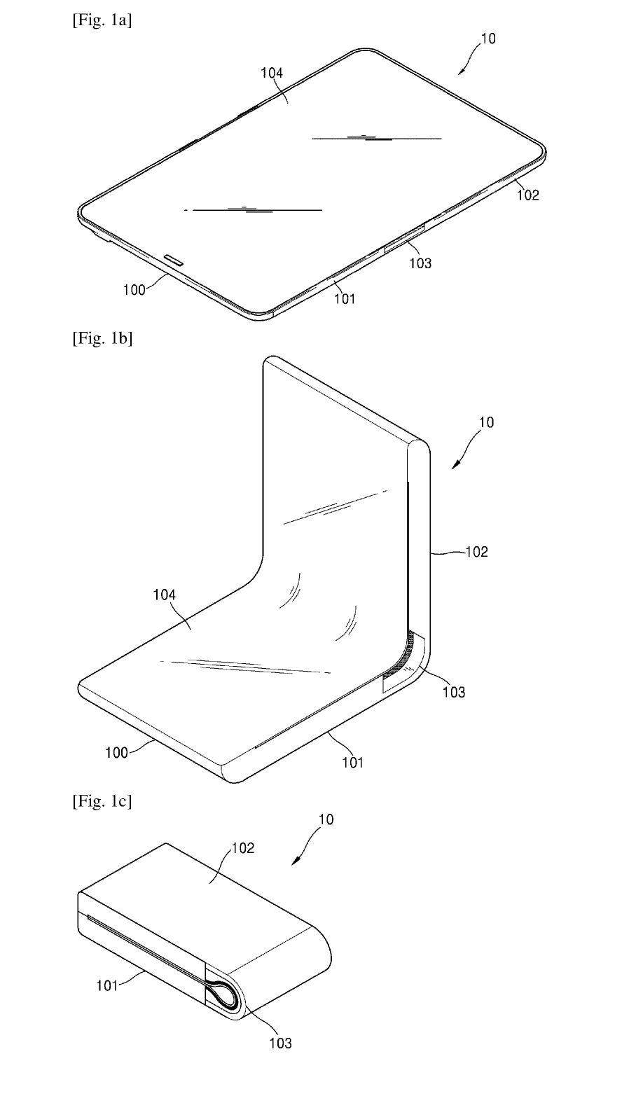

FIGS. 1A through 1C illustrate exterior shapes of a flexible device 10 in correspondence to folding motions of the flexible device 10, according to exemplary embodiments.

The flexible device 10 may be embodied as one of various devices with various purposes. For example, the flexible device 10 may be embodied as a mobile phone, a smart phone, a laptop computer, a tablet device, an electronic-book device, a smart television (TV), a device for digital broadcasting, a personal digital assistant (PDA), a portable multimedia player (PMP), navigation, or the like.

The flexible device 10 employs a flexible display 104. The flexible display 104 may include various types of a display whose shape is deformable due to an external force, wherein the various types include a foldable display that may be folded or unfolded at a particular angle or to have a particular curvature, a bendable display that may be bent or unbent to have a particular curvature, a rollable display that may be cylindrically rolled, or the like.

It is assumed that the flexible device 10 shown in FIGS. 1A through 1C corresponds to a foldable device having the foldable display as a type of the flexible display 104. However, as will be described later with reference to other drawings, the flexible device 10 may correspond to a bendable device having a bendable display, a rollable device having a rollable display, or the like.

Referring to FIGS. 1A through 1C, FIG. 1A is a perspective view illustrating an exterior shape of the flexible device 10 in an unfolded state, according to an exemplary embodiment. FIG. 1B is a perspective view illustrating an exterior shape of the flexible device 10 of FIG. 1A in a bent state, according to another exemplary embodiment. FIG. 1C is a perspective view illustrating an exterior shape of the flexible device 10 of FIG. 1A in a completely folded state, according to another exemplary embodiment.

Referring to FIG. 1A, when the flexible display 104 is used, the flexible device 10 may be completely unfolded, and here, an unfolding angle of the flexible display 104 may be 180 degrees.

According to a structure of the flexible device 10, the flexible device 10 may include the flexible display 104 and a housing 100. The housing 100 corresponds to a body of the flexible device 10, and may support the flexible display 104.

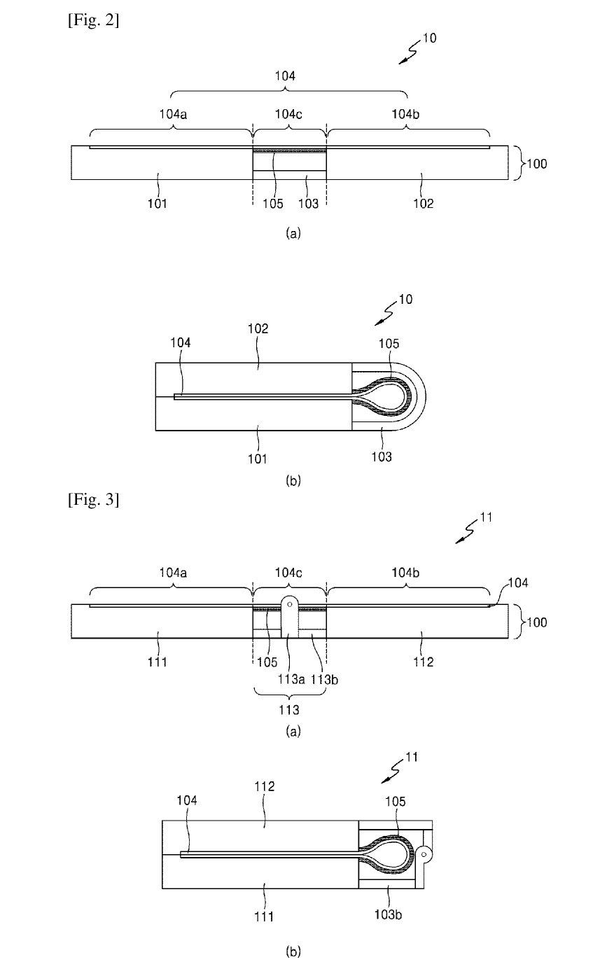

In more detail, the housing 100 may include a first housing 101, a second housing 102, and a connecting part 103. The flexible display 104 may include a first part (e.g., a first part 104a of FIG. 2) supported by the first housing 101, a second part (e.g., a second part 104b of FIG. 2) supported by the second housing 102, and a deformable part 104c (refer to FIG. 2) that is a foldable part between the first part 104a and the second part 104b. The first part 104a and the second part 104b of the flexible display 104 may be fixed parts that are not deformable.

The deformable part 104c of the flexible display 104 is a foldable part and may not be supported by the first housing 101 and the second housing 102. The deformable part 104c of the flexible display 104 may not be supported by the connecting part 103, and may be simply connected with the first part 104a and the second part 104b of the flexible display 104. The deformable part 104c of the flexible display 104 may be supported by a shape maintaining part 105 (refer to FIG. 2) arranged on a rear surface of the deformable part 104c.

The flexible device 10 may be folded as shown in FIG. 1B, and in this regard, an unfolding angle of the flexible display 104 may be between 0 degree and 180 degrees, e.g., 90 degrees. The flexible device 10 may be completely folded as shown in FIG. 1C, and in this regard, the unfolding angle of the flexible display 104 may be 0 degree.

When the flexible device 10 is folded, the housing 100 and the flexible display 104 are also folded. The housing 100 may be folded in a manner that the first housing 101 and the second housing 102 are at a folding position, and the connecting part 103 is deformed while the connecting part 103 maintains its connection with the first housing 101 and the second housing 102.

When the housing 100 is folded, the flexible display 104 is also folded. Here, the first part 104a and the second part 104b that are fixed parts of the flexible display 104 may not be deformed and only the deformable part 104c may be folded. The deformable part 104c of the flexible display 104 may not be sharply folded but may be deformed with a gently-curved shape so as to prevent damage to the flexible display 104.

In more detail, when the flexible device 10 is folded, the housing 100 that supports the flexible display 104 may form a space in which the deformable part 104c that is deformed is enclosed. The space may be formed by the connecting part 103 of the housing 100 or may be formed by the first housing 101 and the second housing 102. The deformable part 104c of the flexible display 104 may be bent in the formed space while the deformable part 104c maintains its curved shaped without being sharply bent.

In this regard, due to the space for preventing damage to the flexible display 104, the flexible display 104 may not be supported such that the flexible display 104 may have an uneven portion. In addition, when a user touches the deformable part 104c of the flexible display 104, the deformable part 104c may not be supported such that an error may occur with respect to a touch input by the user.

In order to solve these problems, the flexible device 10 according to the present exemplary embodiment may include the shape maintaining part 105 at a rear surface of the flexible display 104.

The shape maintaining part 105 may be arranged on the rear surface of the deformable part 104c of the flexible display 104 and thus may control a shape of the deformable part 104c. The shape maintaining part 105 may control the shape of the deformable part 104c by controlling flexibility or flatness of the deformable part 104c. The shape maintaining part 105 may be attached to the rear surface of the deformable part 104c or may contact the deformable part 104c in a close range.

For example, when the flexible display 104 is folded, a shape of the shape maintaining part 105 may be changed according to a folded shape of the flexible display 104. When the flexible display 104 is unfolded, the shape maintaining part 105 may be autonomously unfolded flat and may maintain its shape so as to allow the deformable part 104c of the flexible display 104 to be unfolded flat. Also, the shape maintaining part 105 may support the deformable part 104c by autonomously maintaining its flexibility, and thus may reduce the error with respect to the touch input by the user.

The shape maintaining part 105 may be partially flat unfolded according to an unfolding angle of the folded flexible display 104, and thus may control the flexible display 104 to be smoothly unfolded or folded while the deformable part 104c of the flexible display 104 maintains its curved shape.

The shape maintaining part 105 may be embodied by using a device whose shape is deformed according to a preset condition. In more detail, the shape maintaining part 105 may be embodied of an electroactive device whose shape is deformed due to an electrical signal. For example, the electroactive material whose shape is deformed due to the electrical signal may include electroactive polymer (EAP). The electroactive material to be embodied as the shape maintaining part 105 will be described at a later time.

The shape maintaining part 105 may receive an electrical signal from an electrical signal applier 330 (refer to FIG. 31) to be described later, so as to maintain its shape in correspondence to an unfolding angle of the flexible display 104. In more detail, when the electrical signal applier 330 applies an electrical signal to the shape maintaining part 105, the shape maintaining part 105 may maintain its set shape by contracting or relaxing itself. When the electrical signal applier 330 blocks the electrical signal, the shape maintaining part 105 may be in a flexible state without the set shape and may be deformed according to a shape of the flexible display 104.

For example, when the flexible display 104 is unfolded, the electrical signal applier 330 may apply an electrical signal to the shape maintaining part 105 and may maintain a shape of the shape maintaining part 105. When the flexible display 104 is folded, the electrical signal applier 330 may block the electrical signal with respect to the shape maintaining part 105 and thus may allow the shape of the shape maintaining part 105 to be changed according to a folded shape of the flexible display 104.

The electrical signal applier 330 may apply an electrical signal to all or some portions of the shape maintaining part 105, according to the unfolding angle of the flexible display 104. At least one area and position of an entire area of the shape maintaining part 105 to which the electrical signal is to be applied may be determined according to an unfolding angle of the flexible device 10 or the flexible display 104. For example, as the flexible display 104 is stepwise unfolded and thus the unfolding angle increases, the area of the entire area of the shape maintaining part 105 to which the electrical signal is to be applied may be increased.

The flexible device 10 may determine the unfolding angle of the flexible display 104 by using a sensing unit 320 (refer to FIG. 31) to be described later and may determine, by using the determined unfolding angle, a target area of the entire area of the shape maintaining part 105 to which the electrical signal is to be applied.

The flexible device 10 may maintain flatness and flexibility of the flexible display 104 by using the shape maintaining part 105 that received the electrical signal from the electrical signal applier 330, and thus may allow the flexible display 104 to be smoothly unfolded or folded while the deformable part 104c of the flexible display 104 maintains its curved shape.

FIG. 2 is a cross-sectional side view of the flexible device 10 shown in FIG. 1.

Referring to FIG. 2, (a) of FIG. 2 is a cross-sectional view illustrating a case in which the flexible device 10 is completely unfolded and thus an unfolding angle of the flexible device 10 is 180 degrees, and (b) of FIG. 2 is a cross-sectional view illustrating a case in which the flexible device 10 is completely folded and thus the unfolding angle of the flexible device 10 is 0 degree.

Referring to FIG. 2, the flexible device 10 includes the flexible display 104, and in this regard, the flexible display 104 may be a display that includes the first part 104a and the second part 104b that are fixed and are not deformed, and the deformable part 104c that is foldable.

The flexible device 10 may include the housing 100 that corresponds to a body of the flexible device 10.

The housing 100 may include an exterior case of the flexible device 10 as the body of the flexible device 10, and may include internal configurations for supporting devices. For example, referring to FIG. 2, the housing 100 may include the first housing 101 for supporting the first part 104a, the second housing 102 for supporting the second part 104b, and the connecting part 103 for connecting the first housing 101 and the second housing 102. The internal configurations of the flexible device 10 which include the sensing unit 320, the electrical signal applier 330, a controller (not shown), etc. may be included in the first housing 101 or the second housing 102 of the housing 100.

The first part 104a and the second part 104b of the flexible display 104 may be supported by the first housing 101 and the second housing 102, respectively, in a manner that the first part 104a and the second part 104b are bonded to the first housing 101 and the second housing 102 by using a bonding element such as a bonding material, but one or more exemplary embodiments are not limited thereto and thus the first part 104a and the second part 104b may be fixed through various elements.

The deformable part 104c of the flexible display 104 may not be supported by the housing 100. The deformable part 104c may be neither attached to the first housing 101 and the second housing 102 nor attached to the connecting part 103 but may only depend on its connection with the first part 104a and the second part 104b of the flexible display 104. Alternatively, the deformable part 104c of the flexible display 104 may be supported by the shape maintaining part 105 arranged on a rear surface of the deformable part 104c.

The shape maintaining part 105 may be attached to the rear surface of the deformable part 104c. When the flexible display 104 is unfolded as shown in (a) of FIG. 2, the shape maintaining part 105 may receive an electrical signal from the electrical signal applier 330 and may maintain a preset shape.

In more detail, the flexible device 10 may determine an unfolding angle of the flexible display 104 by using the sensing unit 320, and may determine whether or not to apply the electrical signal to the shape maintaining part 105, according to the unfolding angle. When the flexible device 10 determines that the unfolding angle is 180 degrees, the flexible device 10 may allow the electrical signal applier 330 to apply the electrical signal to the shape maintaining part 105. The shape maintaining part 105 that received the electrical signal may maintain the preset shape and thus may maintain flatness with respect to the attached deformable part 104c.

Comparing (a) and (b) of FIG. 2, since the flexible device 10 is folded, the housing 100 and the flexible display 104 may be folded.

The housing 100 may be folded in a manner that the first housing 101 and the second housing 102 are at a folding position, and the connecting part 103 is deformed while maintaining its connection with the first housing 101 and the second housing 102. The connecting part 103 may be embodied in various ways, and for example, referring to FIG. 2, the connecting part 103 may be embodied of a flexible device such as rubber and may include an internal slit structure.

Even if the unfolding angle of the flexible display 104 is 0 degree as shown in (b) of FIG. 2, the housing 100 may maintain a curved shape by using the slit structure of the connecting part 103 and thus may form a round space in which the deformable part 104c is to be enclosed. The space in the side surface shown in (b) of FIG. 2 may have a cylindrical shape.

The flexible display 104 may be folded because the deformable part 104c is deformed. The first part 104a and the second part 104b that are bonded to the first housing 101 and the second housing 102, respectively, may not be deformed. In this regard, when the housing 100 is folded while forming the space, the deformable part 104c may be deformed while maintaining its curved shape in the space.

When the flexible device 10 is folded as shown in (b) of FIG. 2, the shape maintaining part 105 may be deformed according to a folded shape of the attached flexible display 104.

In more detail, the flexible device 10 may determine, by using the sensing unit 320, the unfolding angle of the flexible display 104 as 0 degree, and may block the electrical signal with respect to the shape maintaining part 105. The shape maintaining part 105 to which the electrical signal is blocked may have a flexible status and thus may be deformed according to the folded shape of the attached flexible display 104.

The deformable part 104c of the flexible display 104 may be tightly enclosed in the round space, and thus may be deformed while the deformable part 104c maintains well its curved shape.

FIG. 3 is a cross-sectional side view of a flexible device 11, according to another exemplary embodiment.

In more detail, (a) of FIG. 3 illustrates a cross-sectional view of a case in which the flexible device 11 is completely unfolded and thus has an unfolding angle of 180 degrees, and (b) of FIG. 3 illustrates a cross-sectional view of a case in which the flexible device 11 is completely folded and thus has the unfolding angle of 0 degree.

With respect to the flexible device 11 of FIG. 3, parts of the flexible device 11 that are same as those of the flexible device 10 of FIG. 2 are not described here.

Referring to FIG. 3, a connecting part 113 of the flexible device 11 may include a hinge 113a including a cylindrical axis, and connectors 113b, and may be embodied to be foldable with respect to the axis of the hinge 113a.

Even if an unfolding angle of a flexible display 104 is 0 degree as shown in (b) of FIG. 3, a housing 110 may form an empty space in the connecting part 113 that is deformed by using a hinge structure, and thus may form a quadrangular space in which a deformable part 104c is to be enclosed. The space shown in (b) of FIG. 3 may have a quadrangular-column shape.

When the housing 110 is folded, the deformable part 104c is deformed so that the flexible display 104 may be folded. A first part 104a and a second part 104b that are bonded to a first housing 111 and a second housing 122, respectively, may not be deformed. In this regard, when the housing 110 is folded while forming the quadrangular space, the deformable part 104c may not be sharply bent and may be deformed while maintaining its curved shape in the space.

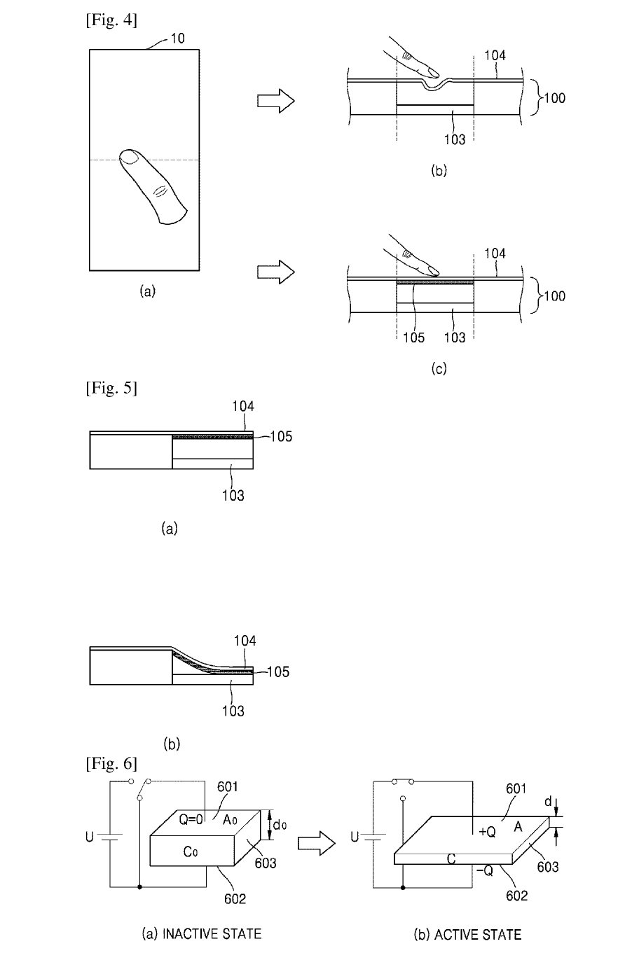

FIG. 4 illustrates the flexible device 10 according to the exemplary embodiment and another flexible device 10 that does not include the shape maintaining part 105 according to a comparative example.

In this regard, (a) of FIG. 4 illustrates that a user touches a folded area of the flexible display 104 of the foldable flexible device 10. The folded area of the flexible display 104 may be a deformable part that is foldable, so that, in order to protect the deformable part, the housing 100 of the flexible device 10 may form an enclosure space at a rear surface of the deformable part.

In this regard, (b) and (c) of FIG. 4 indicate cross-sectional views of the flexible devices 10, each of which having the enclosure space at the rear surface of the deformable part of the flexible display 104. In this regard, (b) of FIG. 4 illustrates the flexible device 10 that does not include the shape maintaining part 105, and (c) of FIG. 4 illustrates the flexible device 10 that includes the shape maintaining part 105. For example, the shape maintaining part 105 may be tightly attached to the rear surface of the deformable part of the flexible display 104.

Regarding (b) of FIG. 4, if the shape maintaining part 105 is not included, the deformable part of the flexible display 104 may not be supported by the housing 100 but may be simply connected with a fixed part of the flexible display 104. Therefore, when the user touches the deformable part of the flexible display 104, the deformable part may be pressed or curved and thus may not correctly receive a touch input by the user.

On the other hand, regarding (c) of FIG. 4, if the shape maintaining part 105 is included, the deformable part of the flexible display 104 may be supported by the shape maintaining part 105. In more detail, the shape maintaining part 105 that received an electrical signal from the electrical signal applier 330 may maintain a preset shape and thus may maintain flatness and flexibility. The shape maintaining part 105 may maintain the preset shape and thus may maintain flatness of the attached deformable part. Therefore, even if the user touches the deformable part, the deformable part may not be pressed or curved and may correctly receive a touch input by the user.

FIG. 5 illustrates an operation principal with respect to the shape maintaining part 105 shown in FIG. 4.

In this regard, (a) and (b) of FIG. 5 illustrate a portion of a cross-sectional side view of the flexible device 10 including the shape maintaining part 105, according to an exemplary embodiment.

In more detail, (a) of FIG. 5 illustrates the shape maintaining part 105 to which an electrical signal is applied. For example, when the flexible device 10 is unfolded, the flexible device 10 may determine an unfolding angle by using the sensing unit 320 and may apply the electrical signal to the shape maintaining part 105. The flexible device 10 may apply the electrical signal to the shape maintaining part 105 by using the electrical signal applier 330.

The shape maintaining part 105 that received the electrical signal may maintain its preset shape by contracting or relaxing itself. The shape maintaining part 105 may autonomously maintain the preset shape and thus may support the deformable part 104c of the attached flexible display 104 so as to allow the flexible display 104 to maintain a shape of the flexible display 104. Therefore, the flexible display 104 may maintain flatness and flexibility of the flexible display 104 without a support by the housing 100.

Also, (b) of FIG. 5 illustrates the shape maintaining part 105 to which an electrical signal is not applied. For example, when the flexible device 10 is folded, the flexible device 10 may determine an unfolding angle by using the sensing unit 320 and may block the electrical signal with respect to the shape maintaining part 105. The flexible device 10 may block the electrical signal with respect to the shape maintaining part 105 by using the electrical signal applier 330.

The shape maintaining part 105 that did not receive the electrical signal is in a flexible state, and is deformed according to a deformed shape of a deformable part of the flexible display 104. For example, as shown in (b) of FIG. 5, in a case where one end from among both ends of the deformable part of the flexible display 104 is connected to a fixed part of the flexible display 104, and the other end is not connected, the flexible display 104 may be deformed while being bent downward. The shape maintaining part 105 is also deformed according to the deformed shape of the deformable part of the flexible display 104.

When the flexible device 10 is unfolded again, the flexible device 10 applies an electrical signal to the shape maintaining part 105, so that the flexible display 104 and the shape maintaining part 105 may return to shapes as shown in (a) of FIG. 5.

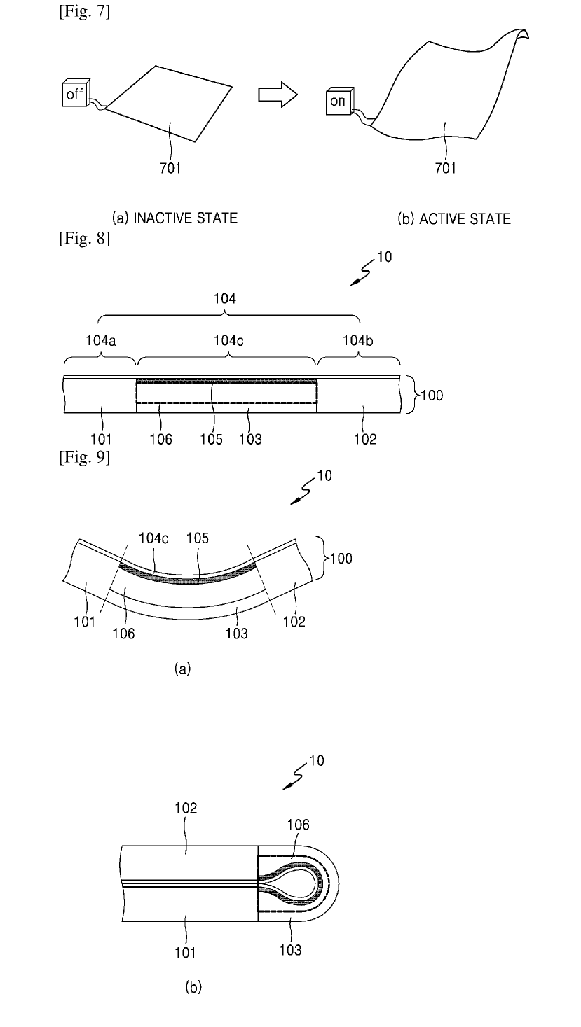

FIGS. 6 and 7 illustrate characteristics of a device that is used in embodying the shape maintaining part 105 described with reference to FIG. 5.

The shape maintaining part 105 may be embodied by using the device whose shape is deformed according to a preset condition. The preset condition may include a preset temperature, a preset pressure, a preset voltage, or the like. For example, the shape maintaining part 105 may include a device such as a shape-memory alloy that is deformed to a preset shape according to the preset temperature.

In the present exemplary embodiment, the shape maintaining part 105 may be embodied of an electroactive device whose shape is deformed due to an electrical signal. For example, the electroactive material whose shape is deformed due to the electrical signal may include electroactive polymer (EAP).

With reference to FIGS. 6 and 7, a characteristic of the EAP for embodying the shape maintaining part 105 is described. Materials other than the EAP may be used in embodying the shape maintaining part 105 by using characteristics similar to the characteristic.

The EAP collectively indicates a polymer material capable of being deformed due to electrical stimulation. Types of the EAP may include a polymer gel, a conducting polymer, an ionic polymer metal composite (IPMC), carbon nanotube (CNT), dielectric elastomer, polyvinylidene fluoride resin (PVDF resin), a shape-memory polymer, electroactive ceramics (EAC), a piezoelectric element, or the like.

Referring to FIG. 6, the EAP may be formed of two electrodes 601 and 602, and an electric material 603 inserted between the two electrodes 601 and 602. For example, the electric material 603 indicates a material such as elastomer whose shape is deformed due to an external force and is returned to its original shape when the external force is removed.

Referring to FIG. 6, (a) of FIG. 6 illustrates the EAP in an inactive state since a voltage is not applied to the EAP, and (b) of FIG. 6 illustrates the EAP in an active state since a voltage is applied to the EAP. When the voltage is applied to the EAP, a voltage difference between the two electrodes 601 and 602 occurs, and then the two electrodes 601 and 602 pressurize the electric material 603 therebetween so as to meet each other, so that deformation as shown (b) of FIG. 6 may be achieved. A shape of the EAP may be differently deformed by adjusting a structure of the EAP or by adjusting strength of the voltage applied thereto.

When the voltage is not applied to the EAP, the EAP may return to its original shape as shown in (a) of FIG. 6, according to a characteristic of the elastomer.

FIG. 7 illustrates an actuator 701 that is a power transmitter for converting an electric energy using the EAP to a mechanical energy.

In this regard, (a) of FIG. 7 illustrates the actuator 701 in an inactive state since a voltage is not applied to the actuator 701, and (b) of FIG. 7 illustrates the actuator 701 in an active state since a voltage is applied to the actuator 701. The actuator 701 in the inactive state may have a flexible status without a fixed shape. The actuator 701 may be controlled in such a manner that, when the voltage is applied to the actuator 701, a shape of the actuator 701 may be deformed to a preset shape according to the characteristic of the EAP described with reference to FIG. 6. In more detail, a structure of the EAP, whether or not to apply a voltage, strength of the voltage to be applied, etc., with respect to each of points of the actuator 701 may be controlled, so that the shape of the actuator 701 may be deformed to the preset shape.

As described above, by using the characteristic of the EAP, the shape maintaining part 105 of the flexible device 10 according to the present exemplary embodiment may be embodied.

The shape maintaining part 105 may be attached to a rear surface of the deformable part of the flexible display 104, and may include a shape maintaining device such as the electroactive device. The shape maintaining device may be disposed so as to allow the shape maintaining part 105 to maintain the preset shape.

The shape maintaining part 105 may include a circuit so as to apply an electrical signal to the shape maintaining device. The shape maintaining part 105 may receive the electrical signal from the electrical signal applier 330 by using the circuit, wherein the electrical signal depends on a deformed status of the flexible display 104.

FIG. 8 is a cross-sectional side view illustrating a portion of the flexible device 10, according to another exemplary embodiment.

In more detail, FIG. 8 is a cross-sectional side view illustrating a folded portion of the flexible device 10 in an unfolded state.

The flexible display 104 of the flexible device 10 may include the first part 104a and the second part 104b that are fixed parts, and the deformable part 104c connected between the first part 104a and the second part 104b.

The first part 104a and the second part 104b may be supported by the first housing 101 and the second housing 102, respectively. The deformable part 104c is not supported by the first housing 101 or the second housing 102 and is simply connected to the first part 104a and the second part 104b.

The first housing 101 and the second housing 102 are foldably connected to each other via the connecting part 103. The first housing 101, the second housing 102, and the connecting part 103 form the housing 100 that is a body of the flexible device 10. The connecting part 103 may be embodied of a flexible device such as rubber and may include an internal slit structure.

The connecting part 103 may have a thickness less than that of each of the first housing 101 and the second housing 102, and an empty space may be formed between the deformable part 104c of the flexible display 104 and the connecting part 103.

The empty space between the deformable part 104c and the connecting part 103 may correspond to an enclosure space 106 in which the deformable part 104c that is deformed when the flexible device 10 is folded is enclosed. The enclosure space 106 is formed to allow the deformable part 104c of the flexible display 104 not to be sharply bent but to be deformed with a curved shape. The enclosure space 106 may be formed when the flexible device 10 is folded or may have been formed since the flexible device 10 is unfolded.

In order to prevent deformation, which is not desired by a user, from occurring at the flexible display 104 due to the enclosure space 106 between the deformable part 104c and the connecting part 103, the flexible device 10 may include the shape maintaining part 105 arranged on a rear surface of the deformable part 104c. The shape maintaining part 105 may include the shape maintaining device, may be attached to the rear surface of the deformable part 104c, and thus may maintain a shape of the deformable part 104c.

FIG. 9 is a cross-sectional side view illustrating a portion of the flexible device 10 shown in FIG. 8 when the flexible device 10 is folded.

When the flexible device 10 is folded, the housing 100 and the flexible display 104 may be folded.

The housing 100 may be folded in a manner that the first housing 101 and the second housing 102 are at a folding position, and the connecting part 103 that connects the first housing 101 and the second housing 102 is deformed while the connecting part 103 maintains its connection with the first housing 101 and the second housing 102. The flexible display 104 may be folded in a manner that the deformable part 104c is deformed. The deformable part 104c may be deformed while maintaining a curved shape of the deformable part 104c.

Referring to (a) of FIG. 9, when the housing 100 is folded, a shape of the enclosure space 106 may be deformed while maintaining room for enclosing the deformable part 104c. The deformable part 104c may be enclosed in the maintaining enclosure space 106 and thus may be deformed while the deformable part 104c maintains the curved shape. Here, the shape maintaining part 105 arranged on the rear surface of the deformable part 104c may maintain a flexible state and thus may be deformed according to a folded shape of the attached deformable part 104c.

As shown in (b) of FIG. 9, when the housing 100 is completely folded, the enclosure space 106 may be formed as a round shape. The housing 100 may actually have a semicircular-column shape. The deformable part 104c of the flexible display 104 may be tightly enclosed in a round space, and thus may be deformed while the deformable part 104c maintains well its curved shape.

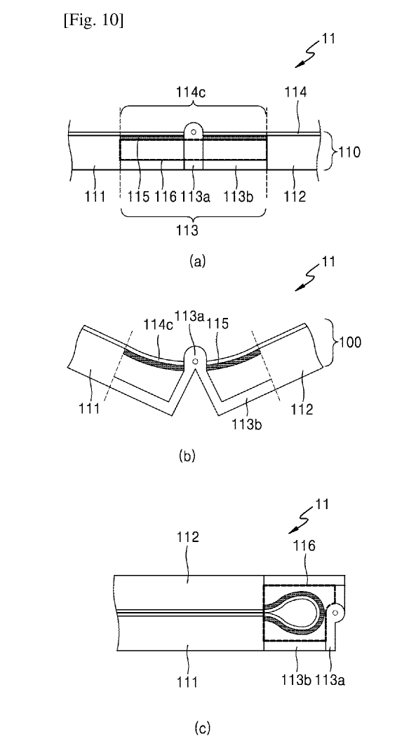

FIG. 10 is a cross-sectional side view illustrating a portion of the flexible device 11, according to another exemplary embodiment.

In more detail, (a) of FIG. 10 is a cross-sectional side view illustrating a folded portion of the flexible device 11 in an unfolded state.

With respect to the flexible device 11 of FIG. 10, parts of the flexible device 11 that are same as those of the flexible device 10 of FIG. 8 are not described here.

Referring to (a) of FIG. 10, the first housing 111 and the second housing 112 are foldably connected to each other via the connecting part 113. The first housing 111, the second housing 112, and the connecting part 113 form the housing 110 that is a body of the flexible device 11. The connecting part 113 may include the hinge 113a including a cylindrical axis, and the connectors 113b, and may be embodied to be foldable with respect to the axis of the hinge 113a.

The connecting part 113 may have a thickness less than that of each of the first housing 111 and the second housing 112, and an empty space may be formed between a deformable part 114c of a flexible display 114 and the connecting part 113.

The empty space between the deformable part 114c and the connecting part 113 may correspond to an enclosure space 116 in which the deformable part 114c that is deformed when the flexible device 11 is folded is enclosed. In order to prevent deformation, which is not desired by a user, from occurring at the flexible display 114 due to the enclosure space 116, the flexible device 11 may include a shape maintaining part 115 arranged on a rear surface of the deformable part 114c.

Also, (b) and (c) of FIG. 10 are cross-sectional side views, each of which illustrating a portion of the flexible device 11 when the flexible device 11 is folded.

Referring to (b) of FIG. 10, when the housing 110 is folded, a shape of the enclosure space 116 may be deformed while maintaining room for enclosing the deformable part 114c. The deformable part 114c may be enclosed in the maintaining enclosure space 116 and thus may be deformed while the deformable part 114c maintains the curved shape. Here, the shape maintaining part 115 arranged on the rear surface of the deformable part 114c may maintain a flexible state and thus may be deformed according to a folded shape of the attached deformable part 114c.

As shown in (c) of FIG. 10, when the housing 110 is completely folded, the enclosure space 116 may be formed as a quadrangular shape. The housing 110 may actually have a quadrangular-column shape. The flexible device 11 may be embodied to have an appropriately-adjusted horizontal length of the connecting part 113 shown in (a) of FIG. 10, so that the flexible display 114 may not be sharply bent. For example, a cusp of a curved surface of the deformable part 114c contacts a central axis of the connecting part 113, so that the deformable part 114c may be deformed while the deformable part 114c is not sharply bent and maintains well a shape of the curved surface.

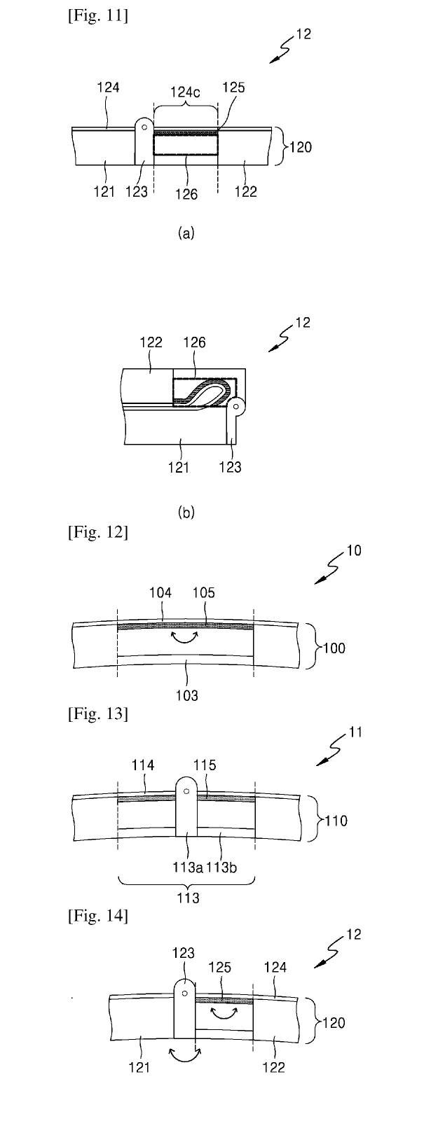

FIG. 11 is a cross-sectional side view illustrating a portion of a flexible device 12, according to another exemplary embodiment.

In more detail, (a) of FIG. 11 is a cross-sectional side view illustrating a folded portion of the flexible device 12 in an unfolded state.

With respect to the flexible device 12 of FIG. 11, parts of the flexible device 12 that are same as those of the flexible device 10 of FIG. 8 are not described here.

Referring to (a) of FIG. 11, a first housing 121 and a second housing 122 are foldably connected to each other via a connecting part 123. The first housing 121, the second housing 122, and the connecting part 123 form a housing 120 that is a body of the flexible device 12. The connecting part 123 may correspond to a hinge including a cylindrical-shape axis between the first housing 121 and the second housing 122.

An enclosure space 126 in which a deformable part 124c that is deformed when the flexible device 12 is folded is enclosed may be formed due to an internal structure of the first housing 121 or the second housing 122. For example, the enclosure space 126 may be formed due to a groove in a side or both sides of the first housing 121 or the second housing 122.

In order to prevent deformation, which is not desired by a user, from occurring at a flexible display 124 due to the enclosure space 126, the flexible device 12 may include a shape maintaining part 125 arranged on a rear surface of the deformable part 124c.

Also, (b) of FIG. 11 is a cross-sectional side view illustrating a portion of the flexible device 12 when the flexible device 12 is folded.

Referring to FIG. 11, when the housing 120 is folded, the enclosure space 126 may not be deformed and may maintain its shape. The deformable part 124c may be enclosed in the enclosure space 126 and thus may be deformed while the deformable part 124c maintains a curved shape of the deformable part 124c. Here, the shape maintaining part 125 arranged on the rear surface of the deformable part 124c may maintain a flexible state and thus may be deformed according to a folded shape of the attached deformable part 124c.

As shown in (b) of FIG. 11, when the housing 120 is completely folded, the enclosure space 126 may be formed as a quadrangular shape. The housing 120 may actually have a quadrangular-column shape. The flexible device 12 may be embodied to have an appropriately-adjusted horizontal length of the enclosure space 126 that corresponds to a groove in the second housing 122 shown in (b) of FIG. 11, so that the flexible display 124 may not be sharply bent and may be deformed while the flexible display 124 maintains well its curved shape.

FIG. 12 is a cross-sectional side view illustrating a portion of the flexible device 10 of FIG. 8 when the flexible device 10 is bent in an opposite direction.

The flexible device 10 according to the previous exemplary embodiment may be a foldable device having a foldable display that is foldable or unfoldable in one direction. For example, when the flexible device 10 is completely unfolded, an unfolding angle of the flexible device 10 may be 180 degrees, and when the flexible device 10 is completely folded, the unfolding angle of the flexible device 10 may be 0 degree. Therefore, when the flexible device 10 is completely unfolded and thus has the unfolding angle of 180 degrees, the flexible device 10 cannot be folded in a direction (i.e., an opposite direction) in which the unfolding angle further increases. If the flexible device 10 is excessively bent in the opposite direction due to an external force, the flexible device 10 may be damaged.

In order to prevent damage to the flexible display 104, the shape maintaining part 105 arranged on the rear surface of the deformable part 104c of the flexible display 104 may maintain a shape of the shape maintaining part 105 and thus may protect the flexible display 104.

In more detail, the flexible device 10 may determine an unfolding angle of the flexible display 104 by using the sensing unit 320, and when the flexible device 10 determines, according to the unfolding angle, that the flexible device 10 is bent in the opposite direction, the flexible device 10 may apply an electrical signal to the shape maintaining part 105. The flexible device 10 may control the electrical signal applier 330 to apply the electrical signal to the shape maintaining part 105.

The shape maintaining part 105 that received the electrical signal may maintain a preset shape and thus may autonomously maintain flatness and flexibility, and may prevent the deformable part 104c of the attached flexible display 104 from being bent in the opposite direction.

FIG. 13 is a cross-sectional side view illustrating a portion of the flexible device 11 of FIG. 10 when the flexible device 11 is bent in an opposite direction.

In order to prevent damage to the flexible device 11, the connecting part 113 may be formed so as to prevent the flexible device 11 from being bent in the opposite direction. The connecting part 113 may be bent in only one direction by limiting a rotating angle of the hinge 113a.

In order to prevent damage to the flexible display 114, the shape maintaining part 115 arranged on the rear surface of the deformable part 114c of the flexible display 114 may maintain a shape of the shape maintaining part 115 and thus may protect the flexible display 114.

In more detail, when the flexible device 11 is completely unfolded, the flexible device 11 may determine an unfolding angle of the flexible display 114 by using the sensing unit 320, and may apply an electrical signal to the shape maintaining part 115. The shape maintaining part 115 that received the electrical signal may maintain a preset shape and thus may autonomously maintain flatness and flexibility, and may prevent the flexible display 114 from being bent in the opposite direction.

FIG. 14 is a cross-sectional side view illustrating a portion of the flexible device 12 of FIG. 11 when the flexible device 12 is bent in an opposite direction.

In order to prevent damage to the flexible device 12, the connecting part 123 may be formed so as to prevent the flexible device 12 from being bent in the opposite direction. The connecting part 123 may be bent in only one direction by limiting a rotating angle of a hinge (not shown). The connecting part 123 may prevent that, when the flexible device 12 is bent in the opposite direction, the first housing 121 and the second housing 122 contact each other at a point other than the connecting part 123 and are bent in the opposite direction.

In order to prevent damage to the flexible display 124, the shape maintaining part 125 arranged on the rear surface of the deformable part 124c of the flexible display 124 may maintain a shape of the shape maintaining part 125 and thus may protect the flexible display 124.

In more detail, when the flexible device 12 is completely unfolded, the flexible device 12 may determine an unfolding angle of the flexible display 124 by using the sensing unit 320, and may apply an electrical signal to the shape maintaining part 125. The shape maintaining part 125 that received the electrical signal may maintain a preset shape and thus may autonomously maintain flatness and flexibility, and may prevent the flexible display 124 from being bent in the opposite direction.

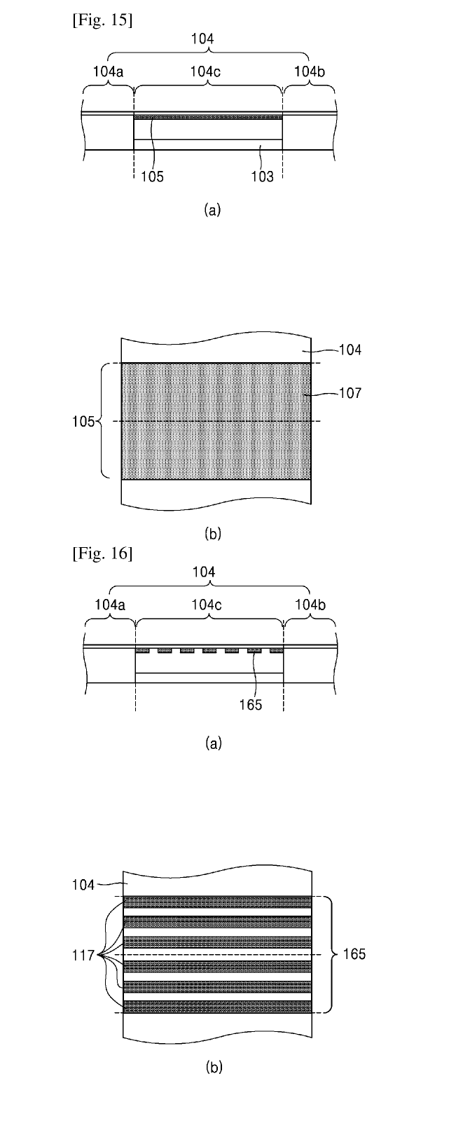

FIG. 15 illustrates the shape maintaining part 105 of the flexible device 10, according to an exemplary embodiment.

The flexible device 10 may include the shape maintaining part 105 arranged on a rear surface of the deformable part 104c that is a deformable part of the flexible display 104. For example, the shape maintaining part 105 may be attached to the rear surface of the deformable part 104c, and may include a shape maintaining device and a circuit for applying an electrical signal to the shape maintaining device.

FIGS. 15 through 19 illustrate a shape maintaining device arranged on a shape maintaining part, according to various exemplary embodiments. In FIGS. 15 through 19, a gray area in the shape maintaining part indicates an area to which the shape maintaining device is attached.

FIG. 15 illustrates an example in which a shape maintaining device 107 is arranged in an entire area of the shape maintaining part 105. In this regard, (a) of FIG. 15 is a cross-sectional side view illustrating a portion of the flexible device 10 including the shape maintaining part 105, and (b) of FIG. 15 is a cross-sectional rear view illustrating a portion of the flexible device 10.

The shape maintaining part 105 including the shape maintaining device 107 arranged in the entire area of the shape maintaining part 105 may collectively control the deformable part 104c. When the shape maintaining part 105 receives an electrical signal from the electrical signal applier 330, the shape maintaining part 105 may maintain a shape of an entire area of the deformable part 104c.

FIG. 16 illustrates a shape maintaining part 165 of the flexible device 10, according to another exemplary embodiment.

FIG. 16 illustrates an example in which shape maintaining devices 117 are arranged in some areas of the shape maintaining part 165. The shape maintaining devices 117 in the form of a plurality of horizontally-long bars may be disposed in the shape maintaining part 165. In this regard, (a) of FIG. 16 is a cross-sectional side view illustrating a portion of the flexible device 10 including the shape maintaining part 165, and (b) of FIG. 16 is a cross-sectional rear view illustrating a portion of the flexible device 10.

Since the shape maintaining devices 117 are arranged at regular intervals, the shape maintaining part 165 may collectively control a shape of the deformable part 104c.

If whether or not to apply an electrical signal varies in the shape maintaining devices 117 in the form of the bars, the shape maintaining part 165 may control a portion of the shape of the deformable part 104c. Since the shape maintaining part 165 controls a portion of the shape of the deformable part 104c, the shape maintaining part 165 may allow the flexible display 104 to be smoothly unfolded or folded while the flexible display 104 maintains a curved shape of the flexible display 104.

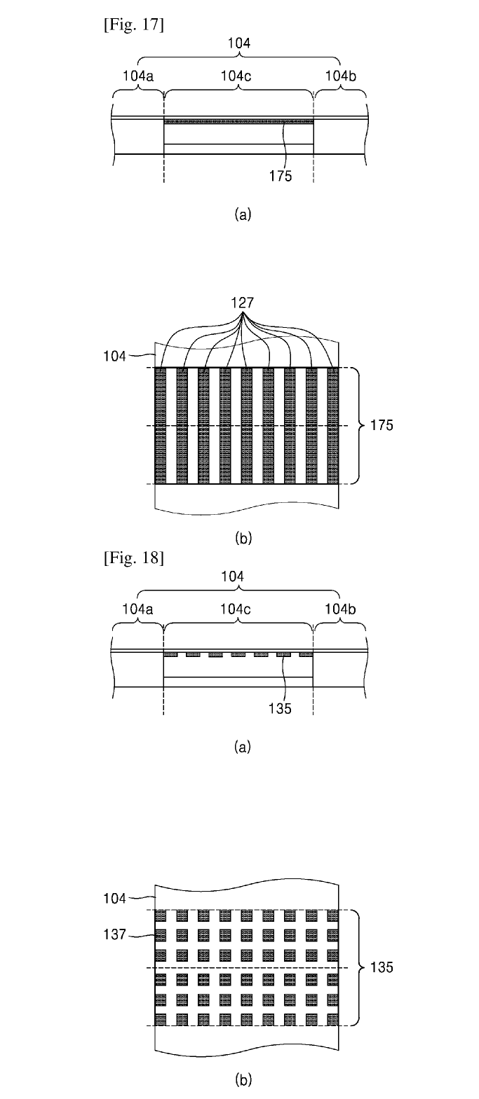

FIG. 17 illustrates a shape maintaining part 175 of the flexible device 10, according to another exemplary embodiment.

FIG. 17 illustrates an example in which shape maintaining devices 127 are arranged in some areas of the shape maintaining part 175. The shape maintaining devices 127 in the form of a plurality of vertically-long bars may be disposed in the shape maintaining part 175. In this regard, (a) of FIG. 17 is a cross-sectional side view illustrating a portion of the flexible device 10 including the shape maintaining part 175, and (b) of FIG. 17 is a cross-sectional rear view illustrating a portion of the flexible device 10.

Since the shape maintaining devices 127 are arranged at regular intervals, the shape maintaining part 175 may collectively control a shape of the deformable part 104c.

If whether or not to apply an electrical signal varies in the shape maintaining devices 127 in the form of the bars, the shape maintaining part 175 may control a portion of the shape of the deformable part 104c. Since the shape maintaining part 175 controls a portion of the shape of the deformable part 104c, the shape maintaining part 175 may allow the flexible display 104 to be smoothly unfolded or folded while the flexible display 104 maintains a curved shape of the flexible display 104.

In addition, when a user unfolds the flexible device 10, the shape maintaining part 175 may create elasticity to make the flexible device 10 unfolded well by using the shape maintaining devices 127 arranged in the form of the vertically-long bars.

FIG. 18 illustrates a shape maintaining part 135 of the flexible device 10, according to another exemplary embodiment.

FIG. 18 illustrates an example in which shape maintaining devices 137 are arranged in some areas of the shape maintaining part 135. The shape maintaining devices 137 having a quadrangular shape may be arrayed in a matrix form in the shape maintaining part 135. In this regard, (a) of FIG. 18 is a cross-sectional side view illustrating a portion of the flexible device 10 including the shape maintaining part 135, and (b) of FIG. 18 is a cross-sectional rear view illustrating a portion of the flexible device 10.

Since the shape maintaining devices 137 are arranged at regular intervals, the shape maintaining part 135 may collectively control a shape of the deformable part 104c.

If whether or not to apply an electrical signal varies in the shape maintaining devices 137 having the quadrangular shape, the shape maintaining part 135 may control a portion of the shape of the deformable part 104c. Since the shape maintaining part 135 controls a portion of the shape of the deformable part 104c, the shape maintaining part 135 may allow the flexible display 104 to be smoothly unfolded or folded while the flexible display 104 maintains a curved shape of the flexible display 104.

The flexible device 10 may apply an electrical signal to the shape maintaining device 137 that is arranged on a rear surface of an area of the flexible display 104, wherein the area of the flexible display 104 is frequently touched or is expected to be touched, so that the flexible device 10 may control a portion of a shape of the deformable part 104c.

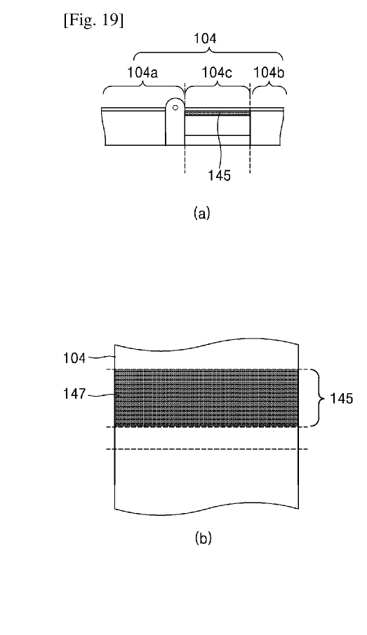

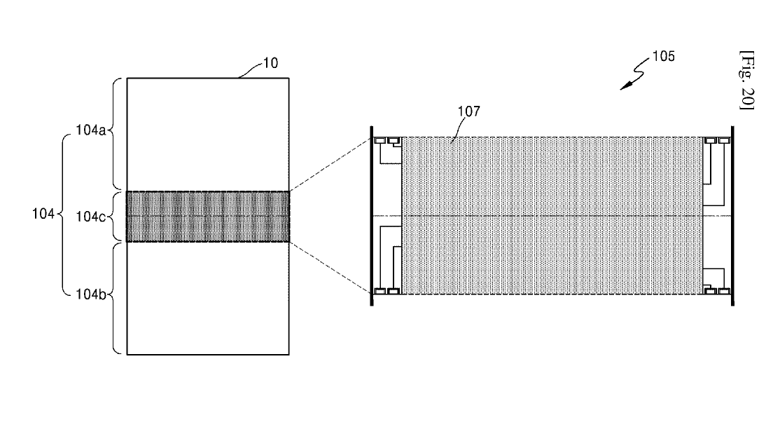

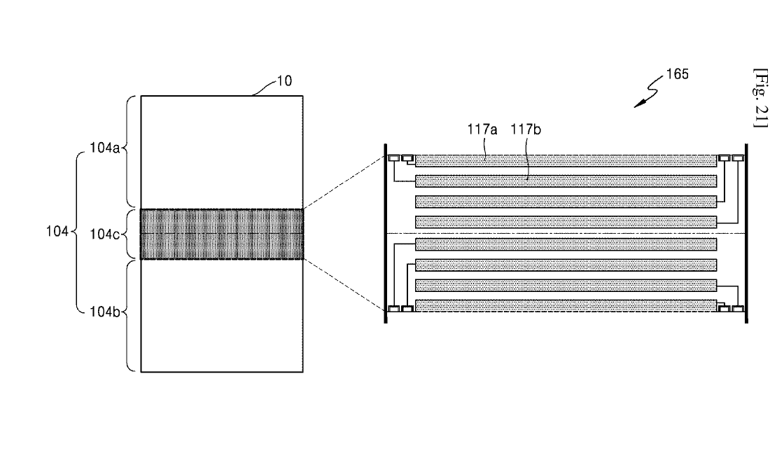

FIG. 19 illustrates a shape maintaining part 145 of the flexible device 10, according to another exemplary embodiment.

FIG. 19 illustrates an example in which a shape maintaining device 147 is arranged in an entire area of the shape maintaining part 145.

However, the shape maintaining part 145 may not be positioned at a folded center of the flexible device 10. According to how a connecting part and an enclosure space of the flexible device 10 are embodied, the deformable part 104c of the flexible device 10 may be arranged at only one of a first housing and a second housing. Therefore, the shape maintaining part 145 arranged on the rear surface of the deformable part 104c may also be arranged at only one of the first housing and the second housing.

In this regard, (a) of FIG. 19 is a cross-sectional side view illustrating a portion of the flexible device 10 including the shape maintaining part 145, and (b) of FIG. 19 is a cross-sectional rear view illustrating a portion of the flexible device 10.

The shape maintaining part 145 including the shape maintaining device 147 arranged in the entire area of the shape maintaining part 145 may collectively control the deformable part 104c. When the shape maintaining part 145 receives an electrical signal from the electrical signal applier 330, the shape maintaining part 145 may maintain a shape of an entire area of the deformable part 104c.

Alternatively, as shown in FIGS. 16 through 18, a plurality of shape maintaining devices may be arranged in some areas of the shape maintaining part 145.

FIGS. 20 through 22 illustrate the shape maintaining parts 105, 165, and 145, according to exemplary embodiments.

In FIGS. 20 through 22, gray areas of the shape maintaining parts 105, 165, and 145 indicate areas to which shape maintaining devices are attached.

FIG. 20 illustrates the shape maintaining part 105 of FIG. 15.

The flexible device 10 may include the shape maintaining part 105 arranged on a rear surface of the deformable part 104c that is a foldable part of the flexible display 104. In more detail, the shape maintaining part 105 may include a shape maintaining device and a circuit, wherein the shape maintaining device maintains a preset shape due to an electrical signal, and the circuit applies the electrical signal to the shape maintaining device. The shape maintaining part 105 may receive the electrical signal from the electrical signal applier 330 via the included circuit.

Referring to FIG. 20, the shape maintaining device 107 may be seamlessly arranged in an entire area of the shape maintaining part 105.

The shape maintaining part 105 may collectively control the deformable part 104c. When the shape maintaining part 105 receives an electrical signal from the electrical signal applier 330, the shape maintaining part 105 may maintain a shape of an entire area of the deformable part 104c.

The shape maintaining part 105 may receive a plurality of electrical signals and may apply different electrical signals to some areas of an entire area of the shape maintaining device 107. In this case, the shape maintaining part 105 may control the shape of the deformable part 104c to another shape or another flexibility while the shape maintaining part 105 collectively controls the deformable part 104c.

FIG. 21 illustrates the shape maintaining part 165 of FIG. 16.

Referring to FIG. 21, a plurality of shape maintaining devices 117a and 117b may be sequentially arranged in an area of the shape maintaining part 165.

The shape maintaining part 165 may collectively control the deformable part 104c by using the plurality of shape maintaining devices 117a and 117b.

The shape maintaining part 165 may receive different electrical signals with respect to the plurality of shape maintaining devices 117a and 117b and may control a portion of a shape of the deformable part 104c. For example, when a remaining power is insufficient and thus there is a demand for power-saving, the flexible device 10 may apply an electrical signal only to the shape maintaining devices 117b from among the plurality of shape maintaining devices 117a and 117b.

The flexible device 10 may apply different electrical signals to the plurality of shape maintaining devices 117a and 117b, respectively, and thus may allow the flexible display 104 to be smoothly folded or unfolded according to an unfolding angle of the flexible display 104 while the deformable part 104c maintains a curved shape.

Compared to the shape maintaining part 105 of FIG. 20, when the shape maintaining part 165 receives different electrical signals and thus controls a shape of the deformable part 104c, the shape maintaining part 165 may further precisely divide and control an area of the shape of the deformable part 104c.

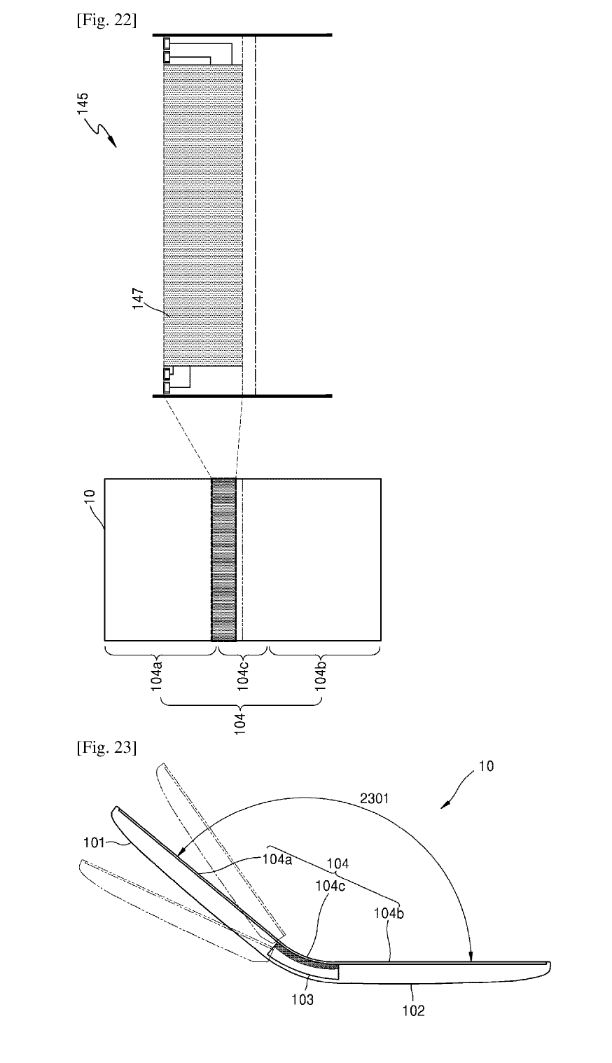

FIG. 22 illustrates the shape maintaining part 145 of FIG. 19.

Referring to FIG. 22, the shape maintaining part 145 may not be positioned at a folded center of the flexible device 10. The shape maintaining part 145 may be arranged at only one of the first housing and the second housing.

Referring to FIG. 22, the shape maintaining device 147 is seamlessly arranged in an entire area of the shape maintaining part 145. Alternatively, as shown in FIG. 21, the shape maintaining device 147 may be disposed in some areas of the shape maintaining part 145.

When the shape maintaining device 147 is arranged in the entire area, the shape maintaining part 145 may collectively control the deformable part 104c. When the shape maintaining part 145 receives an electrical signal from the electrical signal applier 330, the shape maintaining part 145 may maintain a shape of an entire area of the deformable part 104c.

The shape maintaining part 145 may receive a plurality of electrical signals and may apply different electrical signals to some areas of an entire area of the shape maintaining device 147. In this case, the shape maintaining part 145 may control the shape of the deformable part 104c to another shape or another flexibility while the shape maintaining part 145 collectively controls the deformable part 104c.

FIG. 23 illustrates a process of sensing a folding motion of the flexible display 104, according to an exemplary embodiment.

Referring to FIG. 23, the flexible device 10 may sense in real-time a motion for unfolding or folding the flexible display 104 by measuring an unfolding angle 2301. The flexible device 10 may measure the unfolding angle 2301 of the flexible display 104 by using embedded folding sensors.

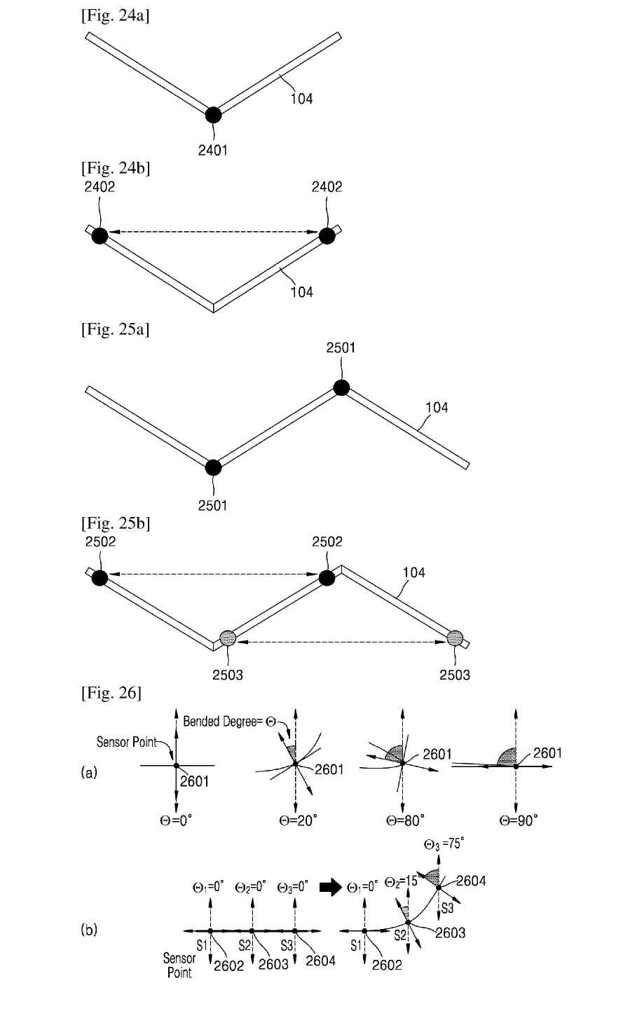

FIG. 24A illustrates a process of sensing a folding motion of the flexible display 104, the process performed by a sensing unit, according to an exemplary embodiment.

Referring to FIG. 24A, it is assumed that the flexible display 104 may be folded by one folding axis. A folding sensor 2401 of the sensing unit may be arranged at a folding axis of the flexible display 104 and may measure an unfolding angle of the flexible display 104. The folding axis indicates a line along which the flexible display 104 is folded, and when the flexible display 104 is symmetrically folded, the folding axis may indicate a center line of the flexible display 104. However, when the flexible display 104 is asymmetrically folded, the folding axis may not indicate the center line of the flexible display 104.

FIG. 24B illustrates a process of sensing a folding motion of the flexible display 104, the process performed by a sensing unit, according to another exemplary embodiment.

Referring to FIG. 24B, similar to FIG. 24A, it is assumed that the flexible display 104 may be folded by one folding axis. However, unlike from the folding sensor 2401 of FIG. 23A, a pair of folding sensors 2402 of the sensing unit shown in FIG. 24B may not be positioned at the folding axis of the flexible display 104 but may be positioned at both ends of the flexible display 104, respectively, and may measure an unfolding angle of the flexible display 104. Here, the pair of folding sensors 2402 of the sensing unit may measure the unfolding angle of the flexible display 104 by measuring a distance between the pair of folding sensors 2402. In this regard, the pair of folding sensors 2402 may be embodied as infrared sensors for distance measurement.

FIG. 25A illustrates a process of sensing a folding motion of the flexible display 104, the process performed by a sensing unit, according to another exemplary embodiment.

Referring to FIG. 25A, it is assumed that the flexible display 104 may be folded by a plurality of folding axes (e.g., two folding axes). Two folding sensors 2501 may be positioned at the two folding axes of the flexible display 104, respectively, and may measure an unfolding angle of the flexible display 104.

FIG. 25B illustrates a process of sensing a folding motion of the flexible display 104, the process performed by a sensing unit, according to another exemplary embodiment.

Referring to FIG. 25B, it is assumed that the flexible display 104 may be folded by a plurality of folding axes (e.g., two folding axes), as shown in FIG. 25A. However, unlike from the folding sensors 2501 of FIG. 25A, two pairs of folding sensors 2502 and 2503 of the sensing unit shown in FIG. 25B may be positioned at both ends of each of the folding axes of the flexible display 104, and may measure unfolding angles of the flexible display 104. Here, the two pairs of folding sensors 2502 and 2503 of the sensing unit may measure the respective unfolding angles of the flexible display 104 by using respective distances between the pair of folding sensors 2502 and between the pair of folding sensors 2503. In this regard, the pair of folding sensors 2502 and 2503 may be embodied as infrared sensors for distance measurement.

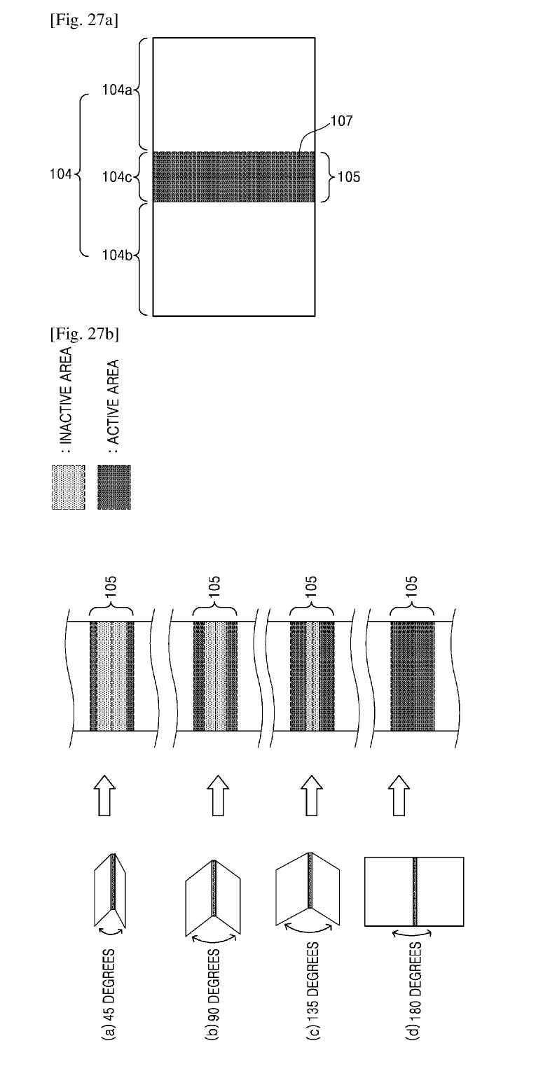

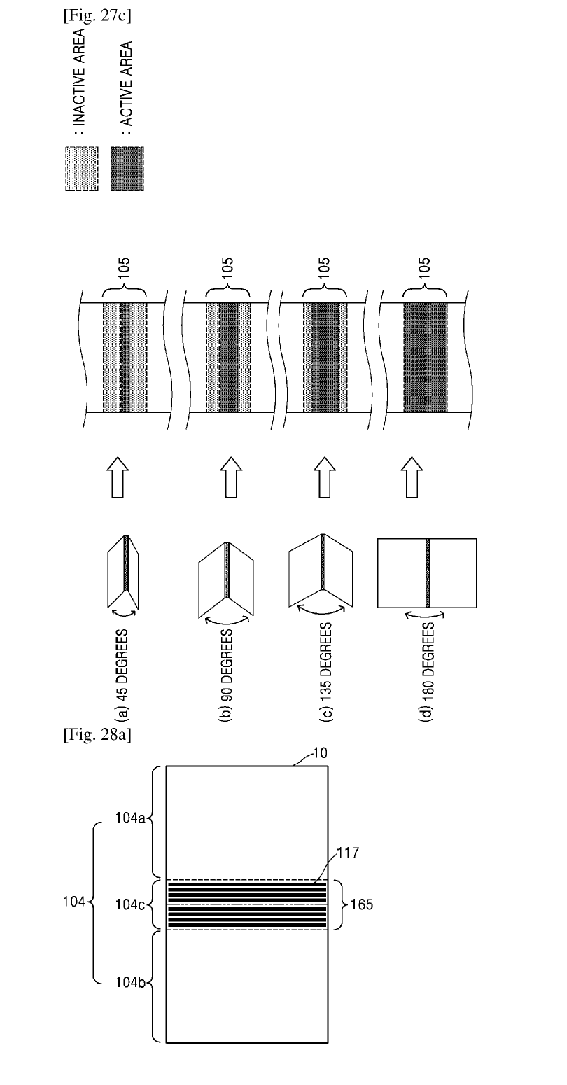

FIG. 26 illustrates a process of sensing a folding motion of the flexible display 104, the process performed by a sensing unit, according to another exemplary embodiment.

Referring to FIG. 26, the sensing unit may collect changes in a value of a sensor point where a folding sensor 2601 is positioned.

Referring to (a) of FIG. 26, the folding sensor 2601 may sense a bending curvature at the sensor point. For example, the folding sensor 2601 may sense the bending curvature from +180 degrees through −180 degrees. Comparing to (b) of FIG. 26, a plurality of folding sensors 2602, 2603, and 2604 arranged at preset intervals may sense bending curvatures at sensor points, respectively.

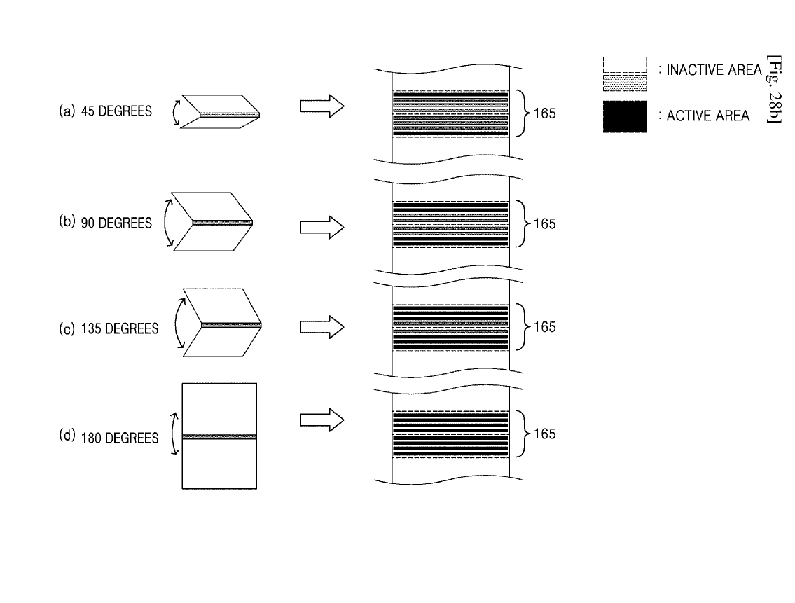

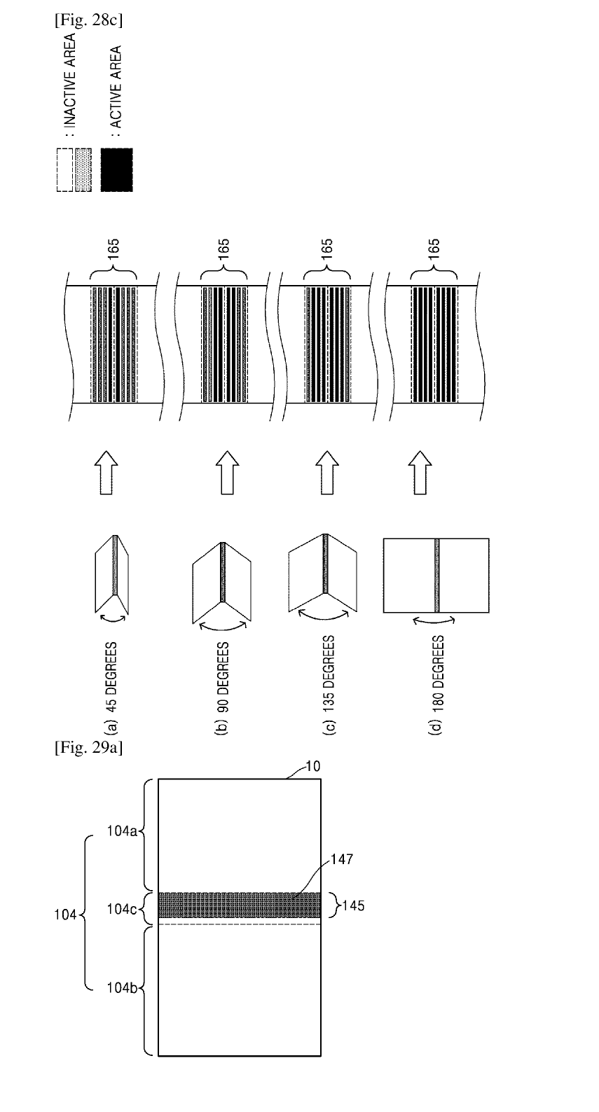

FIGS. 27A through 27C illustrate a procedure of controlling the flexible display 104 of the flexible device 10 including the shape maintaining part 105 of FIG. 20, the procedure performed by the flexible device 10, according to an exemplary embodiment.

As illustrated in FIG. 27A, the flexible device 10 may include the shape maintaining part 105 having the shape maintaining device 107 arranged in an entire area of the shape maintaining part 105.

The shape maintaining part 105 that is tightly attached to a rear surface of the deformable part 104c of the flexible display 104 may receive an electrical signal from the electrical signal applier 330 and thus may be activated. In more detail, an area that is from among the entire area of the shape maintaining part 105 and to which the electrical signal is applied from the electrical signal applier 330 may become an active area, and another area of the entire area to which the electrical signal is not applied may become an inactive area.

The active area of the shape maintaining part 105 may maintain its preset shape and thus may maintain a shape of the deformable part 104c to which the active area is tightly attached. The inactive area of the shape maintaining part 105 may be in a flexible state and thus may be deformed according to a shape of the deformable part 104c to which the inactive area is attached.

The flexible device 10 may allow the electrical signal applier 330 to apply an electrical signal to an entire area or some areas of the shape maintaining part 105, and thus may control the shape of the deformable part 104c attached to the shape maintaining part 105. The flexible device 10 may control the shape of the deformable part 104c to be flat, or may control the flexible display 104 to be smoothly unfolded or folded according to an unfolding angle of the flexible display 104 while the deformable part 104c maintains a curved shape. The flexible device 10 may control the shape and flexibility of the deformable part 104c.

In more detail, FIGS. 27B and 27C illustrate examples of an active area and an inactive area of the shape maintaining part 105 according to unfolding angles of the flexible display 104.

The more the flexible display 104 is unfolded, the wider the area of the shape maintaining part 105 to which an electrical signal is applied by the flexible device 10. In more detail, the flexible device 10 may measure an unfolding angle of the flexible display 104, may determine a position and area of an active area of the shape maintaining part 105 according to the unfolding angle, and may apply the electrical signal to the determined active area.

For example, as the unfolding angle of the flexible display 104 is increased, the flexible device 10 may apply an electrical signal to a wider area of the shape maintaining part 105.

When the unfolding angle of the flexible display 104 is less than 45 degrees, the flexible device 10 may block an electrical signal with respect to the entire area of the shape maintaining part 105, and when the unfolding angle of the flexible display 104 is equal to or greater than 45 degrees, the flexible device 10 may apply the electrical signal to an area of the shape maintaining part 105.

Referring to (a) of FIG. 27B, when the unfolding angle of the flexible display 104 is 45 degrees, the flexible device 10 may apply an electrical signal to some areas of the shape maintaining part 105 that are close to fixed parts of the flexible display 104. Some areas of the shape maintaining part 105 to which the electrical signal was applied become active areas, and other areas of the shape maintaining part 105 become inactive areas. The active areas may be symmetrical with respect to a folding axis of the flexible display 104.

Referring to (b) of FIG. 27B, when the unfolding angle of the flexible display 104 is 90 degrees, the flexible device 10 may apply an electrical signal to some wider areas of the shape maintaining part 105, and thus active areas may be enlarged. Referring to (c) of FIG. 27B, when the unfolding angle of the flexible display 104 is 135 degrees, the flexible device 10 may apply an electrical signal to some wider areas of the shape maintaining part 105, and thus active areas may be further enlarged.

Referring to (d) of FIG. 27B, when the flexible display 104 is completely unfolded and thus the unfolding angle of the flexible display 104 is 180 degrees, the flexible device 10 may apply an electrical signal to the entire area of the shape maintaining part 105, so that the entire area of the shape maintaining part 105 may become a whole active area. The active area may maintain a preset shape and thus may control the shape of the deformable part 104c so as to maintain flatness and flexibility of an attached area of the deformable part 104c.

Referring to FIG. 27C, when an unfolding angle of the flexible display 104 is equal to or greater than 45 degrees, the flexible device 10 may apply an electrical signal to some areas of the shape maintaining part 105 that are close to a folding axis of the flexible display 104. Some areas of the shape maintaining part 105 to which the electrical signal was applied become active areas that are symmetrical with respect to the folding axis of the flexible display 104.

As shown in (b) and (c) of FIG. 27C, when unfolding angles of the flexible display 104 are increased to 90 degrees and 135 degrees, the flexible device 10 may apply an electrical signal to some wider areas of the shape maintaining part 105.

Referring to (d) of FIG. 27C, when the flexible display 104 is completely unfolded and thus the unfolding angle of the flexible display 104 is 180 degrees, the flexible device 10 may apply an electrical signal to an entire area of the shape maintaining part 105, so that the entire area of the shape maintaining part 105 may become a whole active area. The active area may maintain a preset shape and thus may control the shape of the deformable part 104c so as to maintain flatness and flexibility of an attached area of the deformable part 104c.

The flexible device 10 may determine a position and area of an active area of the shape maintaining part 105 according to the unfolding angle of the flexible display 104, and thus may control the flexible display 104 to be smoothly unfolded or folded while the deformable part 104c of the flexible display 104 maintains its curved shape.

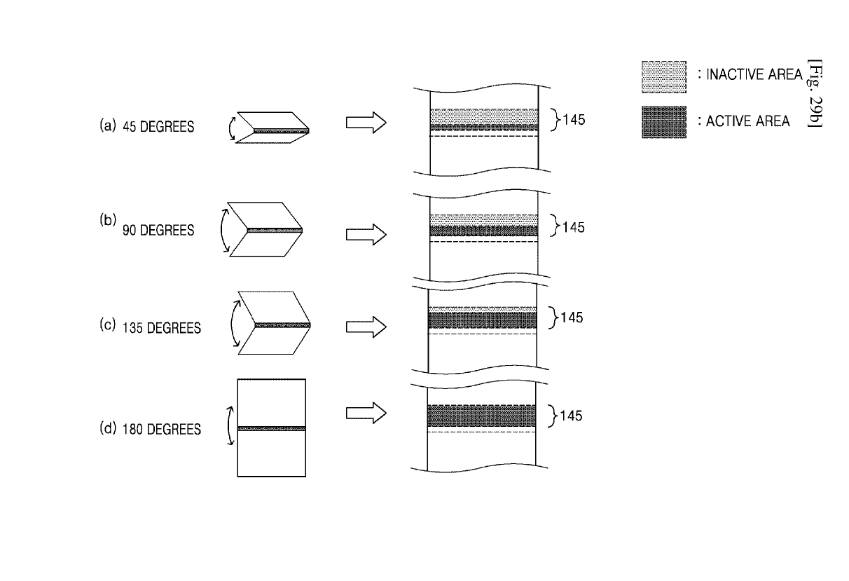

FIGS. 28A through 28C illustrate a procedure of controlling the flexible display 104 of the flexible device 10 including the shape maintaining part 165 of FIG. 21, the procedure performed by the flexible device 10, according to another exemplary embodiment.

As illustrated in FIG. 28A, the flexible device 10 may include the shape maintaining part 165 including the shape maintaining devices 117 that are arranged in some areas of the shape maintaining part 165.

The shape maintaining part 165 that is tightly attached to a rear surface of the deformable part 104c of the flexible display 104 may receive an electrical signal from the electrical signal applier 330 and thus may be activated. In more detail, an area from among an entire area of the shape maintaining part 165 in which the shape maintaining devices 117 having received the electrical signal from the electrical signal applier 330 are arranged may become an active area, and another area of the entire area may become an inactive area. The inactive area may include areas in which the shape maintaining devices 117 are not arranged and areas in which the shape maintaining devices 117 to which the electrical signal is blocked are arranged.

The active area of the shape maintaining part 165 may maintain a preset shape and thus may maintain a shape of the deformable part 104c that is tightly attached to the active area. The inactive area of the shape maintaining part 165 may be in a flexible state, and may be deformed according to a shape of the deformable part 104c that is attached to the inactive area.

The flexible device 10 may allow the electrical signal applier 330 to apply an electrical signal to some areas of the shape maintaining part 165, and thus may control the shape of the deformable part 104c attached to the shape maintaining part 165. The flexible device 10 may control the shape of the deformable part 104c to be flat, or may control the flexible display 104 to be smoothly unfolded or folded according to an unfolding angle of the flexible display 104 while the deformable part 104c maintains a curved shape.

In more detail, FIGS. 28B and 28C illustrate examples of an active area and an inactive area of the shape maintaining part 165 according to unfolding angles of the flexible display 104.

When the flexible display 104 is unfolded, the flexible device 10 may apply an electrical signal to a wider area of the shape maintaining part 165. In more detail, the flexible device 10 may measure unfolding angles of the flexible display 104, may determine, according to the unfolding angles, whether or not to apply an electrical signal to each of areas in which the shape maintaining devices 117 in the form of bars are arranged, and may apply the electrical signal.

For example, as the unfolding angle of the flexible display 104 is increased, the flexible device 10 may apply an electrical signal to the shape maintaining devices 117 in wider areas.

When the unfolding angle of the flexible display 104 is less than 45 degrees, the flexible device 10 may block an electrical signal with respect to the entire area of the shape maintaining part 165, and when the unfolding angle of the flexible display 104 is equal to or greater than 45 degrees, the flexible device 10 may apply the electrical signal to some shape maintaining devices 117 in the shape maintaining part 165.

Referring to (a) of FIG. 28B, when the unfolding angle of the flexible display 104 is 45 degrees, the flexible device 10 may apply an electrical signal to some shape maintaining devices 117 that are close to fixed parts of the flexible display 104. Some areas in which the shape maintaining devices 117 that received the electrical signal are arranged become active areas, and other areas become inactive areas. In this regard, the active areas may be symmetrical with respect to a folding axis of the flexible display 104.

Referring to (b) of FIG. 28B, when the unfolding angle of the flexible display 104 is 90 degrees, the flexible device 10 may apply an electrical signal to the increased number of the shape maintaining devices 117 in the shape maintaining part 165, and the active areas may be enlarged. Referring to (c) of FIG. 28B, when the unfolding angle of the flexible display 104 is 135 degrees, the flexible device 10 may apply an electrical signal to the further-increased number of the shape maintaining devices 117, and the active areas may be further enlarged.

Referring to (d) of FIG. 28B, when the flexible display 104 is completely unfolded and thus the unfolding angle of the flexible display 104 is 180 degrees, the flexible device 10 may apply an electrical signal to all of the shape maintaining devices 117 in the shape maintaining part 165, and all areas in which the shape maintaining devices 117 are arranged may become the active areas. The active areas may maintain a preset shape and thus may control the shape of the deformable part 104c so as to maintain flatness and flexibility of an attached area of the deformable part 104c.

Referring to FIG. 28C, when an unfolding angle of the flexible display 104 is equal to or greater than 45 degrees, the flexible device 10 may apply an electrical signal to some shape maintaining devices 117 that are close to fixed parts of the flexible display 104. Some areas in which the shape maintaining devices 117 that received the electrical signal are arranged become active areas, and in this regard, the active areas may be symmetrical with respect to a folding axis of the flexible display 104.

As shown in (b) and (c) of FIG. 28C, when unfolding angles of the flexible display 104 are increased to 90 degrees and 135 degrees, the flexible device 10 may apply an electrical signal to the shape maintaining devices 117 in wider areas.

Referring to (d) of FIG. FIG. 28C, when the flexible display 104 is completely unfolded and thus the unfolding angle of the flexible display 104 is 180 degrees, the flexible device 10 may apply an electrical signal to all of the shape maintaining devices 117 in the shape maintaining part 165, so that all areas in which the shape maintaining devices 117 are arranged may become active areas. Here, areas in which the shape maintaining devices 117 are not arranged may become inactive areas. The active areas may maintain a preset shape and thus may control the shape of the deformable part 104c so as to maintain flatness and flexibility of an attached area of the deformable part 104c. In this regard, since the inactive areas having flexibility exist between the active areas, the flexible display 104 may be smoothly unfolded or folded while the deformable part 104c of the flexible display 104 maintains its curved shape.

FIGS. 29A and 29B illustrate a procedure of controlling the flexible display 104 of the flexible device 10 including the shape maintaining part 145 of FIG. 22, the procedure performed by the flexible device 10, according to another exemplary embodiment.

As illustrated in FIG. 29A, the flexible device 10 may include the shape maintaining part 145 at a portion of the flexible display 104 that is asymmetrical with respect to a folding axis of the flexible display 104. The shape maintaining part 145 that is tightly attached to a rear surface of the deformable part 104c of the flexible display 104 may be arranged at only one of a first housing and a second housing.

The shape maintaining part 145 may include the shape maintaining device 147 that is seamlessly arranged in an entire area of the shape maintaining part 145.

FIG. 29B illustrates an example of an active area and an inactive area of the shape maintaining part 145 according to unfolding angles of the flexible display 104.

When the flexible display 104 is unfolded, the flexible device 10 may apply an electrical signal to a wider area of the shape maintaining part 145. In more detail, the flexible device 10 may measure an unfolding angle of the flexible display 104, may determine a position and area of an active area of the shape maintaining part 145 according to the unfolding angle, and may apply the electrical signal to the determined active area.

Referring to (a) of FIG. 29B, when the unfolding angle of the flexible display 104 is 45 degrees, the flexible device 10 may apply an electrical signal to some areas of the shape maintaining part 145 that are close to a folding axis of the flexible display 104. Some areas of the shape maintaining part 145 to which the electrical signal was applied may become active areas, and other areas of the shape maintaining part 145 may become inactive areas.

Referring to (b) of FIG. 29B, when the unfolding angle of the flexible display 104 is 90 degrees, the flexible device 10 may apply an electrical signal to some wider areas of the shape maintaining part 145, and thus active areas may be enlarged. Referring to (c) of FIG. 29B, when the unfolding angle of the flexible display 104 is 135 degrees, the flexible device 10 may apply an electrical signal to some wider areas of the shape maintaining part 145, and thus active areas may be further enlarged.

Referring to (d) of FIG. 29B, when the flexible display 104 is completely unfolded and thus the unfolding angle of the flexible display 104 is 180 degrees, the flexible device 10 may apply an electrical signal to the entire area of the shape maintaining part 145, so that the entire area of the shape maintaining part 145 may become a whole active area. The active area may maintain a preset shape and thus may control the shape of the deformable part 104c so as to maintain flatness and flexibility of an attached area of the deformable part 104c.

Even if the shape maintaining part 145 is arranged at only one side of the flexible display 104 with respect to a central axis of the flexible display 104, the flexible device 10 may maintain flatness and flexibility by controlling the shape of the flexible display 104 by using the shape maintaining part 145, or may allow, by controlling the shape of the flexible display 104, the flexible display 104 to be smoothly unfolded or folded while the deformable part 104c of the flexible display 104 maintains its curved shape.

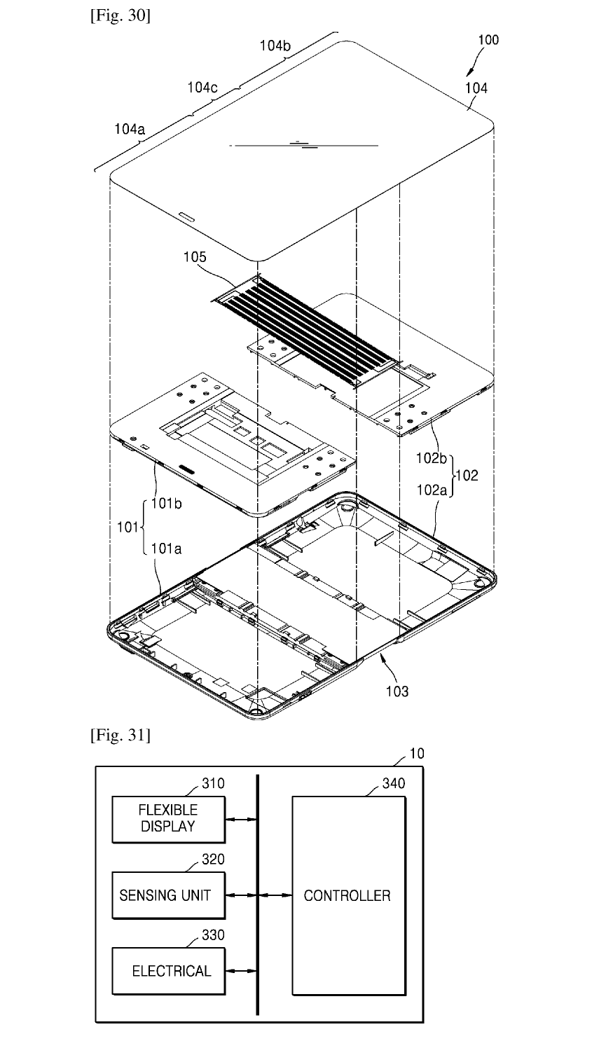

FIG. 30 is an exploded perspective view of the flexible device 10, according to an exemplary embodiment.

Referring to FIG. 30, the flexible device 10 may include the flexible display 104, the shape maintaining part 105, and the housing 100.

The housing 100 that corresponds to a body of the flexible device 10 may include the first housing 101, the second housing 102, and the connecting part 103. The first housing 101 may include an exterior case 101a and a support plate 101b for supporting internal devices and a display (i.e. a display panel). Likewise, the second housing 102 may include an exterior case 102a and a support plate 102b. In addition, the housing 100 may include, in the first housing 101 or the second housing 102, the sensing unit 320, the electrical signal applier 330, a controller (not shown), etc. that correspond to internal configurations of the flexible device 10.

The connecting part 103 that connects the first housing 101 and the second housing 102 may be variously embodied. For example, the connecting part 103 may include the hinge 113a including a cylindrical axis and thus may be embodied to be foldable with respect to the axis of the hinge 113a.

The first part 104a and the second part 104b of the flexible display 104 may be supported by the first housing 101 and the second housing 102, respectively, in a manner that the first part 104a and the second part 104b are bonded to the first housing 101 and the second housing 102 by using a bonding element such as a bonding material.

The deformable part 104c of the flexible display 104 may not be supported by the housing 100. The deformable part 104c may be neither attached to the first housing 101 and the second housing 102 nor attached to the connecting part 103 but may only depend on its connection with the first part 104a and the second part 104b of the flexible display 104. Alternatively, the deformable part 104c of the flexible display 104 may be supported by the shape maintaining part 105 arranged on a rear surface of the deformable part 104c.

The shape maintaining part 105 may be bonded to a rear surface of the deformable part 104c. A shape of the shape maintaining part 105 that does not receive an electrical signal from the electrical signal applier 330 may be changed according to a shape of the bonded deformable part 104c. When the flexible display 104 is folded, the shape maintaining part 105 may receive an electrical signal from the electrical signal applier 330 and thus may maintain a preset shape.

FIG. 31 is a block diagram illustrating a configuration of the flexible device 10 of FIG. 30, according to an exemplary embodiment.

Referring to FIGS. 31 and 30, the flexible device 10 may include a flexible display 310, the sensing unit 320, the electrical signal applier 330, and a controller 340. With reference to FIG. 31, elements related to one or more exemplary embodiments are described so as to prevent the inventive concept from being obscured. In this regard, it is obvious to one of ordinary skill in the art that the flexible device 10 may further include general-use hardware elements as well as hardware elements shown in FIG. 31.

The flexible display 310 is a hardware element that displays information processed in the flexible device 10. The flexible device 10 may provide a user interface screen to a user via the flexible display 310. The flexible display 310 according to one or more exemplary embodiments may be one of different displays such as a foldable display, a bendable display, a rollable display, etc., that are deformable due to an external force.

The flexible display 310 may include a first part and a second part that are non-deformable fixed parts, and a deformable part that is foldable. For example, the first part and the second part may be supported by a first housing and a second housing, respectively.

When the flexible device 10 is folded, the deformable part is deformed and thus allows the flexible display 310 to be folded. The deformable part may not be sharply bent but may be deformed with a gently-curved shape so as to prevent damage to the flexible display 310. The deformable part may be deformed while maintaining the curved shape by using an enclosure space formed by the housing 100.

The deformable part may be supported by the shape maintaining part 105 shown in FIG. 30. In more detail, by using the controller 340, the flexible device 10 may control a shape of the shape maintaining part 105 and may control a shape of the deformable part of the flexible display 310 tightly attached to the shape maintaining part 105.

The sensing unit 320 is formed of sensors and senses a level of deformation of the flexible device 10 or the flexible display 310 that is foldable. The sensing unit 320 may sense a deformation scale of the flexible device 10 or the flexible display 310 while the flexible device 10 or the flexible display 310 is deformed. Since the flexible display 310 is deformed to conform to a shape of the flexible device 10, the level of deformation of the flexible device 10 may correspond to a level of deformation of the flexible display 310.

The sensing unit 320 may sense conversion from a folding state of the flexible device 10 or the flexible display 310 to an unfolding state of the flexible device 10 or the flexible display 310, and may sense an unfolding angle or an unfolding curvature of the flexible device 10 or the flexible display 310. That is, the sensing unit 320 may sense an unfolding motion of the flexible device 10 or the flexible display 310. Likewise, the sensing unit 320 may sense shape conversion from the folding state of the flexible device 10 or the flexible display 310 to the unfolding state of the flexible device 10 or the flexible display 310. That is, the sensing unit 320 may sense a folding motion of the flexible device 10 or the flexible display 310. Here, for convenience of description with respect to one or more exemplary embodiments, only the unfolding angle is described, but even when the unfolding curvature is sensed by the sensing unit 320, one or more exemplary embodiments may be applied thereto and may operate, likewise to the unfolding angle.

When the flexible display 310 is a bendable display, the sensing unit 320 may sense a bending curvature indicating a bending level of the bendable display. When the flexible display 310 is a rollable display, the sensing unit 320 may sense a rolling level of the rollable display. That is, according to types of the flexible display 310, the sensing unit 320 may sense various deformation states corresponding to the types of the flexible display 310.

The electrical signal applier 330 applies an electrical signal to the shape maintaining part 105 shown in FIG. 30, and thus makes all or some areas of the shape maintaining part 105 as an active state or an inactive state.

The electrical signal applier 330 may apply the electrical signal to all or some areas of the shape maintaining part 105 that are determined by the controller 340. All or some areas of the shape maintaining part 105 to which the electrical signal is applied become an active area, and the active area of the shape maintaining part 105 may maintain a preset shape.

The controller 340 is a hardware configuration embodied at least one processor such as a central processing unit (CPU), an application processor (AP), or the like, and controls general operations of the flexible device 10.

The controller 340 may receive, from the sensing unit 320, an unfolding angle of the flexible display 310 that indicates a deformation state of the flexible display 310. Based on the received unfolding angle, the controller 340 may determine an area of the shape maintaining part 105 to which an electrical signal is to be applied and that corresponds to the unfolding angle.

For example, the controller 340 determines whether the unfolding angle is equal to or greater than a preset reference angle. When the unfolding angle is less than the preset reference angle, the controller 340 may determine to block the electrical signal with respect to the shape maintaining part 105, and when the unfolding angle is equal to or greater than the preset reference angle, the controller 340 may determine to apply the electrical signal to all or some areas of the shape maintaining part 105.

As the unfolding angle is increased, the controller 340 may determine to apply the electrical signal to a wider area of the shape maintaining part 105. The controller 340 may determine positions and an area of some areas of the shape maintaining part 105 that correspond to the unfolding angle.

The controller 340 may control the electrical signal applier 330 to apply an electrical signal to all or some determined areas of the shape maintaining part 105.

Likewise, when the flexible display 310 is a bendable display or a rollable display, the controller 340 may determine some areas of the shape maintaining part 105 that correspond to a bending curvature or a rolling curvature.

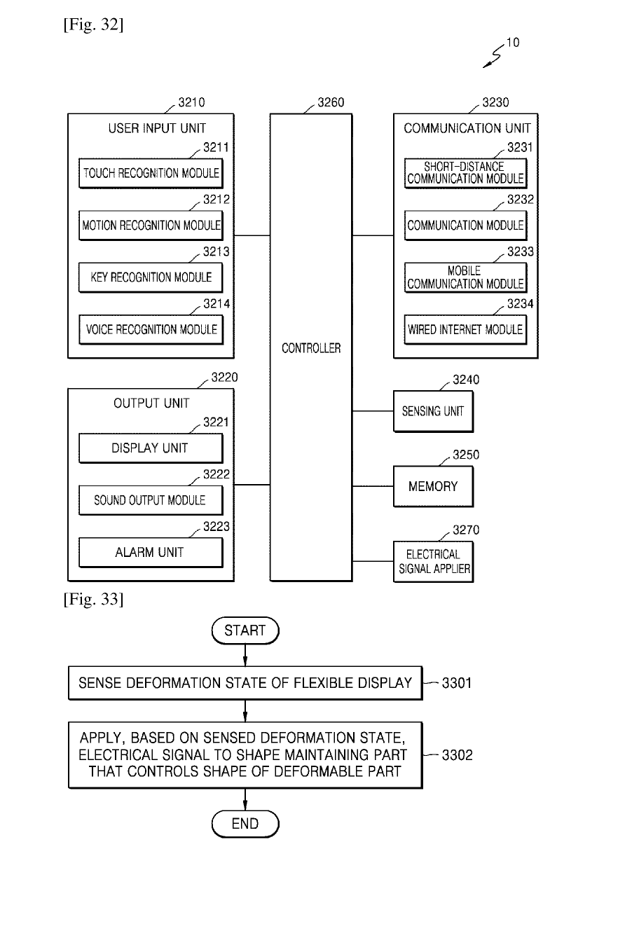

FIG. 32 is a block diagram illustrating a configuration of the flexible device 10, according to another exemplary embodiment.

Referring to FIG. 32, the flexible device 10 may include a user input unit 3210, an output unit 3220, a communication unit 3230, a sensing unit 3240, a memory 3250, a controller 3260, and an electrical signal applier 3270.

The user input unit 3210 may include a touch recognition module 3211, a motion recognition module 3212, a key recognition module 3213, and a voice recognition module 3214, the output unit 3220 may include a display unit 3221, a sound output module 3222, and an alarm unit 3223, and the communication unit 3230 may include a short-distance communication module 3231, a wireless internet module 3232, a mobile communication module 3233, a wired internet module 3234. With reference to FIG. 32, hardware elements related to one or more exemplary embodiments are described so as to prevent the inventive concept from being obscured. In this regard, it is obvious to one of ordinary skill in the art that the flexible device 10 may further include general-use hardware elements as well as hardware elements shown in FIG. 32 or may exclude some of the hardware elements shown in FIG. 32, according to a type of the flexible device 10.

The user input unit 3210 may indicate a hardware configuration used by a user to input information to control the flexible device 10. For example, the user input unit 3210 may be embodied a key pad, a dome switch, a touch pad, a jog wheel, a jog switch, or the like.

The touch recognition module 3211 may sense a touch gesture or a touch input by the user, and may deliver information about the sensed touch gesture or the sensed touch input to the controller 3260.

The touch recognition module 3211 may include various sensors so as to sense a touch or a proximity touch. In order to sense the touch gesture or the touch input, the touch recognition module 3211 may be embodied as a touch capacitive type sensor, a pressure resistive type sensor, an infrared beam sensing type sensor, a surface acoustic wave type sensor, an integral strain gauge type sensor, a piezo effect type sensor, etc.

The touch recognition module 3211 may sense the proximity touch by using a proximity sensor. The proximity sensor senses the existence of an object that approaches a predetermined detection surface or that exists nearby, by using a force of an electro-magnetic field or an infrared ray, instead of a mechanical contact. Examples of the proximity sensor include a transmission-type photoelectric sensor, a direction reflection-type photoelectric sensor, a mirror reflection-type photoelectric sensor, a high frequency oscillation-type proximity sensor, a capacity-type proximity sensor, a magnetic proximity sensor, an infrared-type proximity sensor, or the like.

The touch gesture or the touch input by the user may include a tap gesture, a touch & hold gesture, a double tap gesture, a drag gesture, a panning gesture, a flick gesture, a drag & drop gesture, or the like.

The touch recognition module 3211 and the display unit 3221 may form a mutual layer structure and then may be formed as a touch screen. That is, the flexible display 310 described with reference to FIG. 31 may be embodied as a touchscreen hardware structure including the touch recognition module 3211 and the display unit 3221.

The motion recognition module 3212 may recognize a motion of the flexible device 10, and may deliver information about the motion of the flexible device 10 to the controller 3260. The motion recognition module 3212 may not recognize deformation of the flexible device 10 but may recognize a motion such as three-dimensional (3D) movement or rotation of the flexible device 10.

The motion recognition module 3212 may include various sensors to recognize the motion of the flexible device 10. For example, the motion recognition module 3212 may include an acceleration sensor, a tilt sensor, a gyro sensor, a 3-axis magnetic sensor, etc.

Examples of a motion input that is recognizable to the motion recognition module 3212 may include a 3D motion input by which the flexible device 10 is moved in X, Y, and Z-axes, a rotational motion input by which the flexible device 10 is rotated in at least one direction in a 3D space, a shaking motion input by which the flexible device 10 is shaken in at least one direction, a tilting motion input by which the flexible device 10 tilts in a preset direction, or the like.

The key recognition module 3213 may recognize a user's command input via a hardware key (e.g., a directional key, a letter key, a mouse, etc.). The voice recognition module 3214 may recognize a user's voice by using a voice recognition engine and may deliver a recognized voice to the controller 3260.

The output unit 3220 indicates a hardware configuration to output an audio signal, a video signal, or an alarm signal.

The display unit 3221 is a display interfacing unit for displaying, to a user, various types of information such as information that is processed in the flexible device 10 or information that is to be processed in the flexible device 10. The display unit 3221 may display a graphical user interface (GUI) for visually and intuitionally providing the user with a plurality of pieces of information processed in the flexible device 10. The flexible display 310 described with reference to FIG. 31 has a function of the display unit 3221. Alternatively, the flexible display 310 of FIG. 31 may be embodied as a touchscreen hardware structure including the touch recognition module 3211 and the display unit 3221.

The sound output module 3222 may output audio data that is received from the communication unit 3230 or is stored in the memory 3250. The sound output module 3222 may include a speaker, a buzzer, or the like.

The alarm unit 3223 may generate a signal for notifying the user about an occurrence of an event in the flexible display 310. The alarm unit 3223 may output the signal for notifying the user about the occurrence of the event by using at least one of an audio signal, a video signal, and a vibration signal.

The communication unit 3230 indicates a hardware configuration to communicate with an external network or an external device.

The short-distance communication module 3231 indicates a module for short-distance communication. Examples of a short-distance communication technology may include Bluetooth, Ultra Wideband (UWB), ZigBee, near field communication (NFC), Wi-Fi Direct (WFD), infrared Data Association (IrDA), or the like.

The wireless internet module 3232 indicates a module for accessing wireless internet. The mobile communication module 3233 indicates a module for communicating with a mobile communication network. The wired internet module 3234 indicates a module for accessing wired internet.

The sensing unit 3240 may sense a deforming motion of the flexible device 10 or the flexible display 310, and may deliver information about a sensed deforming motion to the controller 3260. The sensing unit 3240 may sense a deformation state of the flexible device 10 or the flexible display 310 which occurs after the flexible device 10 is opened for use. The sensing unit 3240 may sense the deforming motion of the flexible device 10 by collecting and analyzing the information about the sensed deforming motion by using at least one sensor. In this regard, as described above, the deforming motion may include a folding motion, a bending motion, an unfolding motion, an unbending motion, a rolling motion, or the like. The sensing unit 3240 corresponds to the sensing unit 320 of FIG. 31.

Regarding the deforming motion, the sensing unit 3240 may obtain information about a deformation position (a coordinates value and a deformed line), a deformation direction, a deformation angle, a deformation curvature, a deformation strength, a deformation speed, a number of times of deformation, an occurrence time of the deforming motion, a maintaining time period of the deforming motion, or the like. The sensing unit 3240 may be embodied as a load cell, a bending sensor, an infrared sensor, a pressure sensor, an electromagnetic sensor, or the like.

The sensing unit 3240 may sense a folding motion and a folding angle of the flexible display 310 via procedures described with reference to FIGS. 24A through 25B.

The memory 3250 may indicate a hardware configuration to store a plurality of pieces of information processed in the flexible device 10, and may be embodied as a hard disk drive (HDD), a solid-state drive (SDD), a random-access memory (RAM), a read-only memory (ROM), or the like. For example, the memory 3250 may store a plurality of pieces of general information about a user interface to be displayed via the flexible display 310.

The controller 3260 may indicate a hardware configuration to control general operations and functions of the flexible device 10, and may be embodied as at least one processor such as a CPU, an AP, or the like. The controller 340 of FIG. 31 may correspond to the controller 3260.

The electrical signal applier 3270 may control a shape of the shape maintaining part 105 in a manner that the electrical signal applier 3270 applies an electrical signal to the shape maintaining part 105 of FIG. 30 and thus makes all or some areas of the shape maintaining part 105 as an active state or an inactive state.

FIG. 33 is a flowchart of a method of controlling flexibility of the flexible display 104, the method performed by the flexible device 10 of FIG. 30, according to an exemplary embodiment.

Referring to FIGS. 30 and 33, in operation 3301, the flexible device 10 may sense a deformation state of the flexible display 104.

The flexible device 10 may sense the deformation state of the flexible display 104 by referring to an unfolding angle of the flexible display 104 that is sensed by a sensing unit.

In operation 3302, based on the sensed deformation state, the flexible device 10 may apply an electrical signal to the shape maintaining part 105 that controls flexibility of the deformable part 104c of the flexible display 104.

The flexible device 10 may determine, based on the sensed deformation state, all or some areas of the shape maintaining part 105 to which the electrical signal is to be applied, and may apply the electrical signal to at least one determined area of the shape maintaining part 105.

For example, when the flexible device 10 is completely folded, the flexible device 10 may block an electrical signal with respect to all areas of the shape maintaining part 105, so that a shape of the shape maintaining part 105 may be deformed according to a shape of the deformable part 104c. When the flexible device 10 is completely unfolded, the flexible device 10 may apply an electrical signal to all areas of the shape maintaining part 105, so that the shape maintaining part 105 may maintain a preset shape of the shape maintaining part 105. The flexible device 10 may control, by using the shape maintaining part 105, a shape and flexibility of the deformable part 104c tightly attached to the shape maintaining part 105.

According to an unfolding angle indicating the deformation state of the flexible device 10, the flexible device 10 may vary a position and area of at least one area of the shape maintaining part 105 to which an electrical signal is applied, so that the flexible display 104 may be smoothly folded or unfolded.

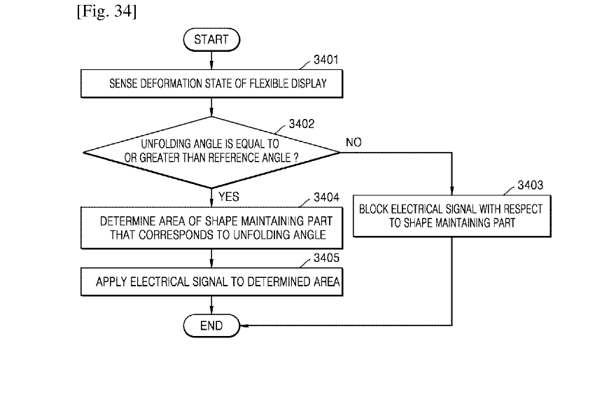

FIG. 34 is a flowchart of a method of controlling flexibility of the flexible display 104, the method performed by the flexible device 10 of FIG. 30, according to another exemplary embodiment.

Referring to FIGS. 30 and 34, in operation 3401, the flexible device 10 may sense a deformation state of the flexible display 104.

The flexible device 10 may sense the deformation state of the flexible display 104 by referring to an unfolding angle of the flexible display 104 that is sensed by a sensing unit.

In operation 3402, the flexible device 10 may determine whether the unfolding angle of the flexible display 104 is equal to or greater than a reference angle.

In operation 3403, when the unfolding angle of the flexible display 104 is less than the reference angle, the flexible device 10 may block an electrical signal with respect to the shape maintaining part 105. In this case, the shape maintaining part 105 may have a flexible status and thus may be deformed according to a shape of the attached deformable part 104c.

In operation 3404, when the unfolding angle of the flexible display 104 is equal to or greater than the reference angle, the flexible device 10 may determine all or some areas of the shape maintaining part 105 to which an electrical signal is to be applied and that correspond to the unfolding angle.

In more detail, the flexible device 10 may determine positions and an area of some areas of the shape maintaining part 105 that correspond to the unfolding angle. For example, the flexible device 10 may determine the positions and the area of some areas of the shape maintaining part 105 in such a manner that, as the unfolding angle is increased, an electrical signal may be applied to a wider area of the shape maintaining part 105.

In operation 3405, the flexible device 10 may apply the electrical signal to the determined areas of the shape maintaining part 105. An active area of the shape maintaining part 105 to which the electrical signal is applied may maintain its preset shape, and thus may maintain a shape of the deformable part 104c.

According to the aforementioned descriptions, when a flexible display is folded, the flexible display may be prevented from being sharply bent and being damaged. When the flexible display is unfolded, flatness of the flexible display may be maintained by using a shape maintaining device. By varying a shape-maintained area according to an unfolding angle of the flexible display, the flexible display may be smoothly folded or unfolded while the flexible display maintains flatness. Since the flatness of the flexible display is maintained, readability for a user may be increased and an error with respect to a touch input by the user may be decreased, and thus, a more accurate user interface manipulation environment may be provided to the user.

The one or more exemplary embodiments can be written as computer programs and can be implemented in general-use digital computers that execute the programs using a computer readable recording medium. In addition, a data structure used in the one or more exemplary embodiments can be written in a computer readable recording medium through various means. Examples of the computer readable recording medium include magnetic storage media (e.g., ROM, floppy disks, hard disks, etc.), optical recording media (e.g., CD-ROMs, or DVDs), etc.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

1. A flexible device comprising:
a flexible display that has a foldable deformable part;
a housing that is foldable and forms an enclosure space in which the deformable part is enclosed when the flexible display is deformed;
a shape maintaining part that is arranged in the enclosure space so as to control flexibility of the deformable part; and
an electrical signal applier that applies an electrical signal to the shape maintaining part, based on a deformation state of the flexible display.

2. The flexible device of claim 1, wherein the flexible display comprises a first part, a second part, and the deformable part between the first part and the second part, and
the first part and the second part are fixed to the housing, and the deformable part is not fixed to the housing.

3. The flexible device of claim 1, wherein the shape maintaining part is arranged on a rear surface of the deformable part in the enclosure space.

4. The flexible device of claim 1, wherein the shape maintaining part comprises a shape-maintaining device whose shape is deformed according to the electrical signal received from the electrical signal applier.

5. The flexible device of claim 1, wherein
when the shape maintaining part receives the electrical signal from the electrical signal applier, the shape maintaining part maintains a preset shape, and
when the electrical signal is blocked, a shape of the shape maintaining part is deformed according to a deformed shape of the deformable part having the shape maintaining part arranged on its rear surface.

6. The flexible device of claim 1, further comprising a sensing unit that senses the deformation state of the flexible display.

7. The flexible device of claim 6, wherein the sensing unit senses the deformation state of the flexible display by sensing an unfolding angle or an unfolding curvature of the flexible display.

8. The flexible device of claim 1, wherein the electrical signal applier applies the electrical signal to an area of the shape maintaining part that corresponds to the deformation state of the flexible display.

9. A flexible device comprising:
a flexible display that has a foldable deformable part;
a sensing unit that senses a deformation state of the flexible display;
an electrical signal applier that applies an electrical signal to a shape maintaining part that is arranged on a rear surface of the deformable part in an enclosure space in which the deformable part is enclosed when the flexible display is deformed; and
a controller that controls the electrical signal applier to apply the electrical signal to the shape maintaining part, based on the deformation state.

10. The flexible device of claim 9, wherein
the sensing unit senses an unfolding angle or an unfolding curvature of the flexible display, and
the controller determines, based on the sensed unfolding angle or the sensed unfolding curvature, whether or not to apply the electrical signal to the shape maintaining part.

11. The flexible device of claim 9, wherein the controller determines, based on the deformation state, an area of the shape maintaining part to which the electrical signal is to be applied.

12. The flexible device of claim 9, wherein the controller determines, based on the deformation state, a magnitude of the electrical signal to be applied to an area of the shape maintaining part.

13. A method of controlling flexibility of a foldable deformable part of a flexible display, the method comprising:
sensing a deformation state of flexible display; and
applying, based on the deformation state, an electrical signal to a shape maintaining part that controls the flexibility of the deformable part,
wherein the shape maintaining part is arranged on a rear surface of the deformable part in an enclosure space in which the deformable part is enclosed when the flexible display is deformed.

14. The method of claim 13, wherein the sensing comprises sensing the deformation state by sensing an unfolding angle or an unfolding curvature of the flexible display.

15. The method of claim 13, wherein the applying comprises applying the electrical signal to an area of the shape maintaining part that corresponds to the deformation state.

16. The method of claim 13, wherein the applying comprises:
based on the deformation state, determining whether or not to apply the electrical signal to the shape maintaining part; and
when it is determined to apply the electrical signal, applying the electrical signal to the shape maintaining part.

17. The method of claim 13, wherein the applying comprises:
based on the deformation state, determining an area of the shape maintaining part to which the electrical signal is to be applied; and
applying the electrical signal to the determined area of the shape maintaining part.

18. The method of claim 13, wherein the applying comprises:
based on the deformation state, determining a magnitude of the electrical signal to be applied to an area of the shape maintaining part; and
applying the electrical signal having the determined magnitude to the area of the shape maintaining part.

19. A non-transitory computer-readable recording medium having recorded thereon a program for executing the method of claim 13, by using a computer.
